(19) United States
(12) Patent Application Publication
(10) Pub. No.: US 2008/0065437 A1
(43) Pub. Date: Mar. 13, 2008

(54) System and Method for Budgeting, Planning, and Supply Chain Management

(76) Inventor: Alan J. Dybvig, Princeton, NJ (US)

Correspondence Address: ICE MILLER LLP, ONE AMERICAN SQUARE, SUITE 3100, INDIANAPOLIS, IN, 46282-0200, US

(21) Appl. No.: 11/661,793

(22) PCT Filed: Aug. 31, 2005
(86) PCT No.: PCT/US05/30813

§ 371 Date: Mar. 1, 2007

Related U.S. Application Data
(60) Provisional application No. 60/696,642, filed on Jul. 6, 2005.

(51) Int. Cl. G06Q 10/00

(52) U.S. Cl. 705/7

(57) ABSTRACT

A system and method for optimizing planned profitability and network design. The system integrates sales and marketing planning and budgeting with the supply chain. This integration is achieved by inclusion of data representative of non-physical sales, general, and administrative (SG&A) costs, by development of response curves including sales and marketing SG&A costs, and by development of capacitation cost curves including nonphysical SG&A costs and supply chain costs. The optimality of the plan according to the present invention is made possible by applying optimization techniques to the integrated data. The optimality of the network design according to the present invention is made possible by making demands available for optimization.

### RELATED APPLICATIONS

This non-provisional patent application based on U.S. provisional patent application Ser. No. 60/606,642, filed Sep. 1, 2004.

### BACKGROUND OF THE INVENTION

This invention relates to an improved system and method for data processing and forecasting refinement, and in particular to a system and method for budgeting and planning management, and supply chain network design and management.

According to the Council of Supply Chain Management Professionals, the definition of a supply chain is:
1) starting with unprocessed raw materials and ending with the final customer using the finished goods, the supply chain links many companies together. 2) the material and information interchanges in the logistical process stretching from acquisition of raw materials to delivery of finished products to the end user. All vendors, service providers and customers are linked in the supply chain.
   (Supply Chain Visions, Logistics Terms and Glossary, compiled by K. Vatasek, 2005, Council of Supply Chain Management, page 96)]. A similar definition is, “The most common definition . . . is a system of suppliers, manufacturers, distributors, retailers and customers where materials flow downstream from suppliers to customers and information flows in both directions.” Quantitative Models for Supply Chain Management, edited by Tayur, Ganesham and Magazine, 1998, Kluwer Academic Publishers, page 842. For purpose of this application, the definition of a supply chain is “ . . . a connected series of activities which is concerned with planning, coordinating and controlling materials, parts, and finished goods from supplier to customer. It is concerned with two distinct flows (material and information) through the organization.” Integrating the Supply Chain, International Journal of Physical Distribution & Materials Management 19; 3-8 1989.

Supply chain network design and management activities do not encompass all business activities and processes, and, thus, to not take into account all costs that a company incurs in producing and selling its products. Specifically, supply chain activities do not include any general administrative costs and activities, including, in particular, sales and marketing activities and costs. Such sales and marketing activities are referred to herein as “demand drivers”. It is therefore desired to provide a system and method for budgeting and planning management, and supply chain network design and management that takes into account such costs, including demand drivers.

In the prior art, the optimal network design of a supply chain are “systems employed in optimizing the relationships among the elements of the supply chain-manufacturing plants, distribution centers, points-of-sale, as well as raw materials, relationships among product families and other factors to synchronize supply chains at the strategic level.” Id. at 97. Such systems usually use a mixture of integer and linear programming (See Modeling the Supply Chain, Shapiro, 2001, Duxbury Thomson Learning, pages 139-151) to address questions such as: Where are the various activities of the supply chain performed? What activities are performed at each site? What are the capacities of the various activities at the various locations? “The state of the art model . . . is a single-period, deterministic minimization of the total supply chain cost of a meeting a given demand.” Id. at 385.

While each prior art practitioner has his/her own methodology, most are likely to include most, if not all, of the following activities, some of which are overlapped in the actual project plan, in the network design of a supply chain: (1) Business Assessment, (2) Model Build, (3) Data Collection, including Aggregation and Analysis, (4) Validate Model, (5) Scenario Development, (6) Run and Analyze Scenarios, (7) Develop Redesigned Network, and (8) Implementation Formulation.

Inherent in the technique of using a mixture of linear and integer programming is the fact that the optimality of the network design is a function of the extent to which various elements in the network are fixed as opposed to being available for optimization. As a pioneer in supply chain analytics stated, “The more tradeoffs optimized simultaneously, the more benefits obtained . . . . ” SynQuest European Sales Meeting, Paul Bender, February 2001. For example, a network design of just the outbound finished goods network will yield fewer benefits than a network designed to include procurement, the inbound network, manufacturing, and the outbound network. Thus, it is desired to provide an optimal network design that encompasses a reasonable number of elements available for optimization. Such “reasonable number” is influenced by the ability of the user to comprehend and utilize such a system for the benefits of inclusion of the elements for optimization.

The prior art network designs most frequently minimize cost. In those selected situations when profit is maximized, not all costs are included in the network design. See Shapiro, pages 326-327. Thus, the prior art network designs are necessarily sub-optimal because: (a) true profit, as defined by the company (e.g., as filed with the SEC, EBITDA, etc.) is not maximized, nor are comparisons made for networks designed with corporate metrics other than profit (e.g., economic value) as the object function; and (b) demand is not modeled as a variable, specifically, as a function of demand driver expenditures. Instead, demand is fixed, thereby reducing the optimality of the solution.

As previously mentioned, supply chain network design and management systems do not take into account demand drivers—sales and marketing activities and processes. Usually, companies develop a business plan for an upcoming fiscal year, with such plans including demand forecasts and the associated manufacturing volumes, financial performance projections, demand driver expenditures, budgets, etc. In forward-looking companies, the planning process is driven by sales and marketing, with the customer and demand planning as the key driving the remaining activities in the planning process.

As is explained in greater detail herein, according to the prior art, a variety of techniques exist to develop the total marketing budget including advertising, sales promotion, public relations and publicity, personal selling, and direct marketing expenditures. Four such techniques are known as affordable, percentage of sales, competitive parity, and objective and task. Quoting from Marketing Management, Kotler, 11th Ed., 2003, Pearson Education, page 755, “How do companies decide the promotion budget? We will describe four common methods: the affordable method, percentage-of-sales method, competitive-parity method and objective-and-task method.” Summarized below are the four models, including the identification of shortcomings with those for the objective-and-task method provided by Kotler and by the applicant:

| Method | Description | Shortcomings | |
|---|---|---|---|
| Affordable | What the | 1. | Completely ignores role of marketing |
| | company can | | budget as an investment and its immediate |
| | afford | | impact on sales volumes. |
| | | 2. | Leads to uncertain budgets; long range |
| | | | planning difficult. |
| Percentage | Specific % of | 1. | Views sales as determiner or budget, rather |
| of sales | sales (current or | | than as the result. |
| | projected) or | 2. | Budget set by availability of funds, not |
| | sales price | | opportunity. |
| | | 3. | Discourages experimentation with counter |
| | | | cyclical promotion or aggressive spending. |
| | | 4. | Interferes with long rang planning |
| | | 5. | No logical basis for choosing specific % |
| | | 6. | Does not encourage budgeting by what each |
| | | | product and territory deserve. |
| Competitive | Budget set to | 1. | No basis for believing competitors know |
| parity | achieve “share- | | better. |
| | of- voice” parity | 2. | Companies' resources, reputations, |
| | with competitors | | opportunities and objectives differ so much |
| | | | marketing budgets are hardly a guide. |
| | | 3. | No evidence that budgets based on |
| | | | competitive parity discourage price wars. |
| Objective | Define specific | 1. | Does not address interaction across |
| and task | objectives and | | objectives; budget is sum of the parts, |
| | tasks to | | rather than the result of a single holistic |
| | accomplish, | | analysis. |
| | estimate costs to | 2. | Does not allow trade-offs with other |
| | accomplish tasks | | demand-driver activities & alternatives like |
| | and sum | | product improvements, better service, |
| | costs(A) | | financial terms, etc. |
| | | 3. | Profit not maximized with true |
| | | | optimization techniques. |

Other more general shortcomings voiced about the prior art of the sales and marketing planning process include: “Our research and experience indicates that marketing planning remains one of the greatest bastions of management ignorance.” Marketing Plans That Work, McDonald and Keegan, 2002, Butterworth-Heinemann, page 211. “Many CEOs see their marketing departments as ‘ill-focused and overindulged,’ ‘unimaginative,’ generating few new ideas, no longer delivering.” Counter-Intuitive Marketing, Clancy and Krieg, 2002, The Free Press, page 18. “The annual marketing plan is a hoax perpetrated on senior management. And it's a hoax we observe every day in companies large and small across a broad range of consumer and business-to-business product categories.” Id. at 243. “Over and over again marketing is the practice of running the same kinds of inadequate marketing programs year in and year out.” Id. at xi.

Another shortcoming mentioned by Clancy and Krieg is that the sales and marketing planning process is not integrated with other planning activities or the various sales and marketing activities themselves. “What shouldn't have surprised use but did was the total lack of connection between every section of the plan.” Counter-Intuitive Marketing, Clancy and Kreig, 2002, The Free Press, page 243.

Also, the sales and marketing plans are often repetitive and without creativity. “There is ample evidence of international companies with highly formalized systems that produce static and repetitive plans . . . . There is clearly a need, therefore, to find a way of perpetually renewing the planning life cycle, each time around,” McDonald and Keegan at 204.

As a result, many managers view the planning process as a ritual rather than a useful tool. The prior art sales and marketing planning and budgeting processes are separate from supply chain network design and management and as a result they:
Miss profit improvement opportunities, perhaps as much as 15% to 30%.
Do not permit for comparisons as optimal results are obtained using object functions other than profit, such as shareholder value, economic value, customer equity, so the company cannot access the extent to which different corporate objectives are compatible.
Cannot realign sales and marketing budgets during the plan's execution when significant changes in performance or assumptions occur during the plan's execution. Therefore, profit improvement opportunities are missed.
Because the volume relationship to non-physical costs such as selling, general and administrative (“SG&A”) expenses, including sales and marketing costs, are not included, these volume/costs relationships cannot be made analytically more accurate over time.
   It is therefore desired to provide a system and method for sales and marketing budgeting and planning that addresses these shortcomings.

Further, the sales and marketing budgeting process is a part of a larger, company-wide budgeting process with significant shortcomings. Traditionally, three different budgeting processes have evolved: authoritative, participative, and consultative. In all three processes, the budget for the next time period builds upon the previous period's budget, with some minor adjustments. In most cases, the past is unreliable in representing the future, and may only account for inflation and no other variable. Further, all three processes are subject to budget “gaming”. Quoting from Management Accounting, Atkinson et al., 2001, Prentice Hall, page 477, “Budgeting games: a process in which managers attempt to manipulate information and targets to achieve as high a bonus as possible.”
Summarizing prior art company-wide budgeting shortcomings more generally:

“Traditional planning and budgeting methods carry many unpleasant connotations due to somewhat dysfunctional practices. Plans and budgets may be highly detailed, but they have low confidence. The detail may imply accuracy and precision but the assumptions are questionable. There are often too many iterations based on organizational politics that still arrive at unrealistic projections of expenses.”

Activity-Based Cost Management, Cokins, 2001, Wiley, page 306. Or, stated another way: “Conventional budgeting practice is an iterative, negotiating process between heads of responsibility centers and senior executives. Responsibility center managers continually seek more resources while senior executives continually attempt to control increases in the spending authorized for their decentralized units. The results is that the budget for the next year builds on that of the previous year, plus or minus a few percent depending upon the outcome of the negotiations between senior executives and local management.” Cost and Effect, Kaplan and Cooper, 1997, Harvard Business School Press, page 302.

One prior art attempt to address these company-wide budgeting shortcomings is known as activity-based budgeting (“ABB”). In ABB, “costs previously thought to be fixed are made variable.” Kaplan at 301. “Activity-based budgeting gives organizations the opportunity to authorize and control the resources they supply based on the anticipated demands for the activities performed by the resources.” Id. at 302. According to ABB, the next period's expected production and sales volumes by individual products and customers are estimated. Next, the demand for organizational activities are forecasted. Then, the resource demands necessary to perform the organizational activities are calculated. Next, the actual resources required to meet the demands are determined. Finally, the activity capacity is determined. ABB does not, however, provide a system and method for optimizing true profit. In addition, ABB does not recognize explicitly that demand is a function of demand driver expenditures, but, instead, demand is fixed. It is therefore desired to provide a system and method for company-wide budgeting, planning, and supply chain management that considers demand as a variable, driven by demand driver costs and optimizes true profit or any other business metric for the organization.

ABB further requires collection of very detailed data, with such collection burdensome to gather. Quoting from Kaplan, “In practice, of course, ABB is not a simple exercise. The organization will have to specify far more details about how production and sales demands will be met, about the underlying efficiency of all organizational activities, and about the spending and supply pattern of individual resources.” Id. at 312. Also, despite the fact that a great deal of detail is required to support ABB, the results are inaccurate because not all spending is covered by the ABB process. Kaplan refers to these additional costs not included in the ABB as “discretionary spending”. Quoting from Kaplan,
Activity-based budgeting is most useful for resources performing repetitive activities . . . . In addition to this derived demand for the organizational resources performing repetitive activities, the budgeting team must also estimate the quantity of discretionary spending for the upcoming year. This spending will typically represent elements of product-and-customer-sustaining expenses, plus spending at higher hierarchical levels (brand and product line, channel and region).
   Id. at 311-312.

Thus, traditional allocation budgeting techniques are still required to be performed for the costs not covered by ABB. The traditional allocation budgeting techniques are necessarily inaccurate because the maximally profitable quantities are not known prohibiting allocation thereof. It is therefore desired to provide a system and method for budgeting, planning, and supply chain management that does not require the collection of a great level of detail, thereby reducing administrative costs associated therewith; and covers all spending without resorting to allocation.

Application of ABB also results in the following shortcomings:
Profit improvement opportunities, perhaps as much as 15% to 30%, are missed.
Comparisons are not possible as optimal results are obtained using object functions other than profit, so that the company cannot assess the extent to which different corporate objectives are compatible.
Demand cannot be redesigned during the plan's execution when significant changes in performance or assumptions occur, as one cannot realign the demand driver expenditures during the plan's execution. As a result, profit improvement opportunities are missed.
Volume/cost relationships cannot be made analytically more accurate over time, because the volume relationship to non-physical costs are not included in the model.
   It is therefore desired to provide a system and method for company-wide budgeting and planning that avoids the above shortcomings of planning and budgeting by prior art methods, in general, and with ABB, in particular.

One prior art company-wide planning and analysis process is known as activity-based management (“ABM”). As described in Cost and Effect, Kaplan, 1998, Harvard Business School, at page 137, activity-based management “refers to the entire set of actions that can be taken, on a better informed basis, with activity-based cost information . . . . ABM accomplishes its objectives through two complimentary applications, which we call organizational activities as given, and attempts to meet this demand with fewer organizational resources . . . doing this right . . . . Strategic ABM—doing the right things—attempts to alter the demand for activities to increase profitability.” It is important to note, however, that the prior art approaches to strategic activity-based management are applied company-wide only to historic data and only applied very narrowly to forecasted or planned data (viz, predicatively); nothing like on the scale they are applied historically. Thus, strategic activity-based management does not address the desire to integrate demand drivers with supply chain management.

If profiling “fully loaded” profit and loss (“p/l”) using strategic ABM, the profiles generated for either products or customers according to the method are necessarily suboptimal. This suboptimality arises because many costs are allocated, and, therefore, do not reflect the actual relationship these costs have with volume. The cost/volume relationships for fixed costs, frequently referred to as sustaining costs, are arbitrarily made linear by assuming an allocation scheme.

If profiling a non-fully loaded p/l using strategic ABM, profiles generated for either products or customers are necessarily inaccurate because many sustaining costs are ignored.

Further, profiles can only be created for one attribute at a time—not combinations, such as products and customers—with strategic ABM. Because it is not possible to simultaneously profile products and customers, product profiles have unprofitable customers embedded therein, and customer profiles have unprofitable products embedded therein. Thus, the most profit effective actions to address both are not possible with ABM. Also, as previously mentioned, comprehensive predictive profiles cannot be created with ABM. Therefore, it is desired to provided a system and method that does not include the shortcomings associated with strategic ABM. Such a system and method should be able to generate optimal fully loaded profiles for either products or customers, generate accurate non-fully loaded profiles for either products or customers, generate profiles for more than one attribute at a time, and generate comprehensive predictive profiles.

In summary, it is therefore desired to develop a system and method for budgeting, planning, and supply chain management, including network design, that maximizes profit or any other corporate metric desired, rather than minimizing cost using true optimization techniques including no allocation of costs. Such a system and method should accommodate all costs, including “demand driver” costs. Also, demand should not be fixed to limit the benefits of optimization, but, rather, a function of demand driver costs.

### SUMMARY

The present invention comprises a system and method for optimizing profitability and network design. A supply chain network design system according to the present invention comprises data storage media used for storing data used in the development of the network design. The data includes data representative of the cost of goods sold and the finished goods network, as well as data representative of non-physical selling, general, and administrative (SG&A) costs. Such SG&A costs include costs such as sales and marketing expense, customer financial expenses, costs associated with a customer, costs associated with a product, costs independent of a customer, and costs independent of a product.

The supply chain network design system of the present invention also includes a processor operably connected to the database. Further, the database of the network design system is capable of storing response cost curves and capacitation cost curves. The processor is operable to create a calibration model using the response cost curves and capacitation cost curves, and to create a network design model from the calibration model.

According to one embodiment of the method of the present invention, a network design model is created for a time period by: (a) creating response cost curves and capacitation cost curves, with the capacitation cost curves including non-physical SG&A costs; (b) creating alternate network configurations; (c) loading the response cost curves, the capacitation cost curves, and the alternate network configurations into a calibration model; and (d) creating a network design model from the calibration model. According to this method, the network design model considers demand as a variable.

One embodiment of the planning and budgeting system of the present invention includes a processor for creating a three-dimensional planning and analysis solution space. The dimensions of this space are volume, profit, and scenario assumptions. The scenario assumptions include demand drivers.

The planning and budgeting system according to one embodiment of the present invention includes a processor and a database operably connected to the processor. The database is used to store response cost curves and capacitation cost curves, with the capacitation cost curves including non-physical SG&A costs and supply chain costs. The processor is operable to create a calibration model using the response and capacitation cost curves, and to create a planning and budgeting model from the calibration model. The planning and budgeting model is created using optimization techniques—a mixture of linear and integer programming solution techniques.

According to one embodiment of the method of planning and budgeting, response cost curves and capacitation cost curves are created, with the capacitation cost curves including non-physical SG&A costs. The response cost curves and capacitation cost curves are loaded into a calibration model. Then, the planning and budgeting model is created by use of optimization techniques, such that the planning and budgeting model considers demand as a variable.

The present invention involves the creation of historic and predictive whale curve analysis as well. For historic whale curve analysis, the processor is used to create a calibration model using response cost curves and capacitation cost curves stored on the database, and then to create profit profiles with multiple criteria (“criteria” are variables by which profit is to be profiled, such as product, customer, channel, geography, etc.) by optimization techniques. For predictive whale curve analysis, the database stores an optimized planning and budgeting model, and the processor creates appropriate sets of multiple criteria and uses optimization techniques to create predictive whale curves for the next time period using such criteria, based on the response cost curves for the next time period.

According to one embodiment of the method for budgeting, planning, and supply chain management for a time period, a model is built and then calibrated. Pre-plan analysis scenarios are then created and loaded, one at a time, into the calibration model. Solutions are then obtained, thereby creating a pre-plan volume/profit/scenario solution space. Pre-plan analysis is then performed of the solutions plotted in the space to inform, for the next period, the most appropriate scenarios, response cost curves, capacitation cost curves, and other criteria. Then, plan analysis is performed by loading planning and budgeting information created by traditional planning and budgeting techniques into the calibration model, and then running scenarios for the time period, creating the current plan volume/profit/scenario solution space. Current plan analysis is then performed by comparing the solutions plotted in the space and the scenario chosen which results and assumptions best meet the company's objectives. This plan replaces the place developed by traditional methods.

If desired, the method of budgeting, planning, and supply chain management for a time period can include historical whale curve analysis and/or predictive whale curve analysis. In addition, in-period adjustments can be made throughout a period. Finally, variance analyses can be performed at the conclusion of a time period to compare actual performance versus planned performance.

The present invention integrates sales and marketing planning and budgeting with the current supply chain, and can so do company-wide. The invention is optimal for network design by the inclusion of non-physical SG&A costs not considered with prior art systems. The present invention avoids missed profit opportunity and employs true optimization techniques. By use of the present invention, a sales and marketing budget can be realigned when significant changes in performance or assumptions occur during execution of the method of the present invention.

The method of the present invention is not solely dependent upon the past for planning, and takes more variables into account. The present invention does not require the collection of a great level of detail, thereby reducing total prior art administrative costs. With the present invention, the cost/volume relationships are not made arbitrarily linear, and, therefore, the present invention allows for the generation of fully loaded profiles for either products or customers, to generate accurate non-fully loaded profiles for either products or customers, to generate profiles for more than one criteria at a time, and to generate predictive profiles.

In addition to maximization of planned profit, the system and method of the present invention simultaneously develops a company-wide activity-based budget, predictive product/customer/etc. profit profiles, and historic product/customer/etc. profit profiles. The present invention subsequently optimizes the design of the supply chain by using the information so developed.

### BRIEF DESCRIPTION OF THE DRAWINGS

FIG. 1 shows a block diagram of one embodiment of the system according to the present invention.

FIG. 2 shows a diagrammatic view of one embodiment of the model structure for network design of the system and used in the method according to the present invention.

FIG. 3 shows a diagrammatic view of a model structure for supply chain network design according to the prior art.

FIG. 4 shows a block diagram of the relationship of demand drivers and demand according to one embodiment of the present invention.

FIG. 5 shows a block diagram of the relationship of demand to the non-demand driver costs according to one embodiment of the present invention.

FIG. 6 shows a flow chart of one embodiment of the method according to the present invention.

FIG. 7 shows a flow chart of the calibration and building of the model according to one embodiment of the present invention.

FIG. 8 shows a table of examples of scenario used in one embodiment of the method of the present invention.

FIG. 9 shows a graph of the results of profit maximization analysis according to one embodiment of the present invention.

FIG. 10 shows a graph of the results of economic value maximization analysis according to one embodiment of the present invention.

FIG. 11 shows a matrix of an example of the relationship of demand drivers to demand according to the present invention.

FIG. 12 shows a matrix of the example of FIG. 11 with notes regarding the development of demand response curves according to the present invention.

FIG. 13 shows a graph of an example of a demand response curve according to the present invention.

FIG. 14 shows a graph of a whale curve according to the prior art.

FIG. 15 shows a flow chart of adjustments made during a plan period according to one embodiment of the present invention.

FIG. 16 shows a flow chart of post-plan analysis according to one embodiment of the present invention.

FIG. 17 shows a flow chart of network design according to one embodiment of the present invention.

### DETAILED DESCRIPTION

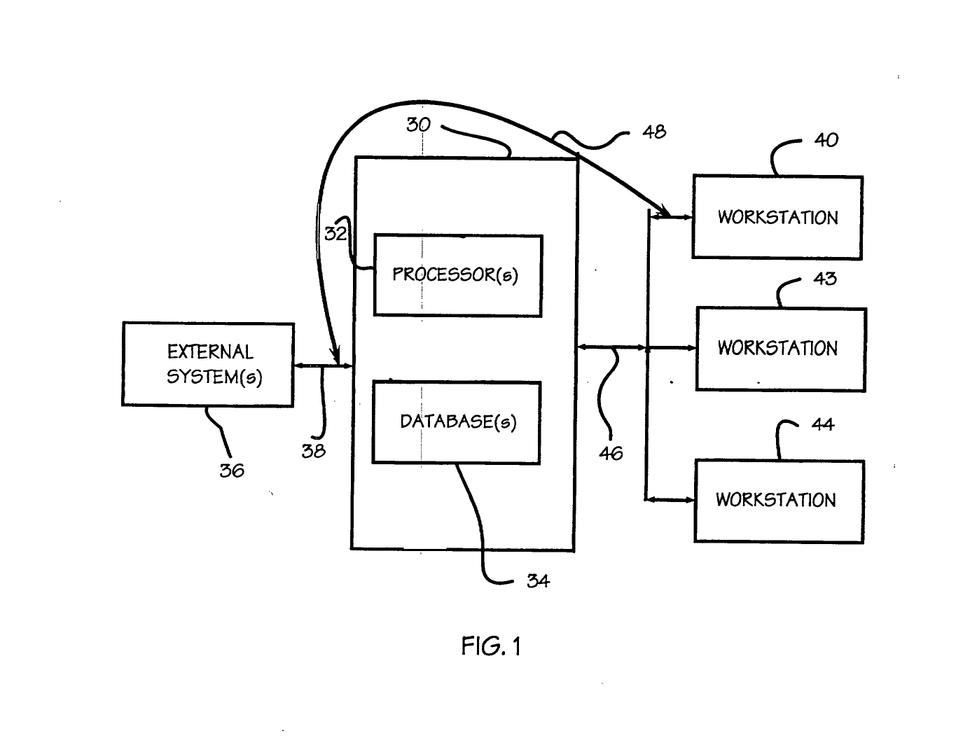

Referring now to FIG. 1, there is shown a block diagram of one embodiment of the system according to the present invention. In this embodiment, the system comprises computer 30, external system(s) 36, first workstation 40, second workstation 42, third workstation 44, first network 38 and second network 46. Computer 30 comprises processor(s) 32 and database(s) 34 used to execute the method of the present invention, and to hold the data used and generated by the present invention, respectively. Computer 30 may comprise the combination of one or more computing device, including but not limited to one or more personal computers, one or more servers, or a combination of processors and databases connected for operation as a unit. External system(s) 36 comprise one or more systems having data of use to computer 30. External system(s) 36 are optional, as computer 30 may hold all of the data used by computer 30 for the present invention. An example of an external system may be a supply chain management system containing data related to manufacturing costs.

In one embodiment, first, second, and third workstations 40, 42, and 44 each comprise a personal computer having at least one input device and at least one output device. Each of workstations 40, 42, and 44 may comprise any computing device, including but not limited to one or more personal computers, one or more servers, or a combination of processors, input devices, and display devices. The at least one input device of workstations 40, 42, and 44 is used for providing instructions to computer 30 and may comprise a keyboard, mouse, track pad, touch screen, voice activation system, or other input device well-known in the art. The at least one output device of workstations 40, 42, and 44 is of the type used to convey feedback from computer 30 to each of workstations 40, 42, and 44, and may comprise a monitor, printer, microphone, or other output device well-known in the art. It is also within the scope of the invention for a workstation to be an integral part of computer 30.

Computer 30 is connected by first network 38 to external system(s) 36. Computer 30 is also connected by second network 46 to workstations 40, 42, and 44. First and second networks 38 and 46 each comprise a bidirectional means of communication of data, and may comprise electrical, infrared or other waves, optical, and/or satellite connections as are well-known in the art. Each of first network 38 and second network 46 may comprise more than one connection and each of these connections need not be of the same type within either of the first or second network 38 or 46, and first and second network 38 and 46 need not be of the same type.

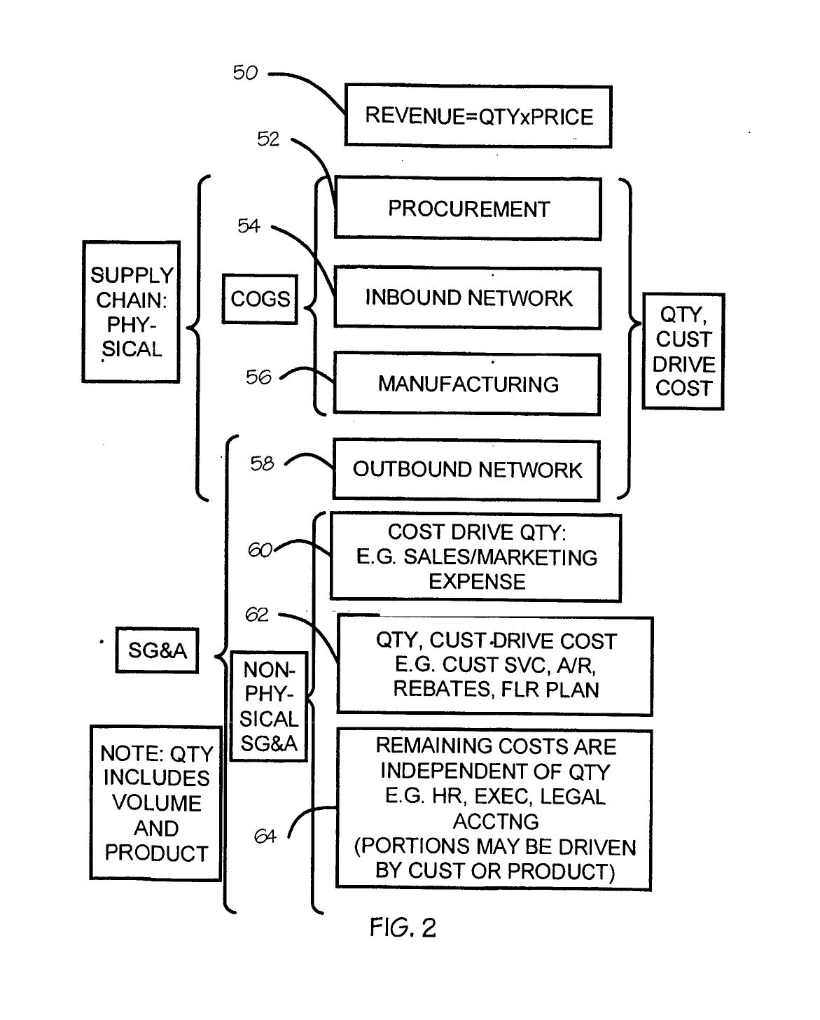

FIG. 2 shows a diagrammatic view of one embodiment of the model structure for planning/budgeting and network design of the system and as used in the method according to the present invention. In this embodiment, the model structure of the present invention includes data representative of the cost of goods sold, and data representative of selling, general, and administration costs. Another way to categorize these costs is as supply chain costs and non-supply chain costs. The supply chain costs are generally the costs of the product in its various physical stages (e.g., raw materials, work in progress, finished goods, etc.) and the costs of the product's physical movement or storage (e.g., transportation, warehousing, distribution centers, delivery, etc.).

The model determines revenue as quantity times price (see item 50) and, thus, models profit/loss based on demand. Data representative of costs of goods sold include procurement costs 52, inbound network costs (links, cross docks, etc.) 54, and manufacturing costs 56. Data representative of selling, general, and administrative costs include outbound network (links, distribution centers, warehouses, etc.) 58, sales and marketing expenses (customer, product, brand, channel, etc.) 60, costs driven by quantity and customer 62, and costs not driven by quantity—some of which are fixed and some of which are driven by customers or products or both and other factors such as invoice lines 64.

As described above, the selling, general, and administration (“SG&A”) costs represented in the present invention include both supply chain or physical costs and non-supply chain costs or non-physical costs. Physical SG&A costs include outbound network costs 58. Non-physical SG&A costs include sales and marketing expenses 60, costs driven by quantity and customer 62, and costs not driven by quantity—some of which are fixed and some of which are driven by customers or products or both, or others such as invoice lines 64.

It will be appreciated by those of skill in the art that other types of expenses may be added to those shown in the embodiment of FIG. 2 and be within the scope of the present invention including the network design. Such costs include those driven by quantity including product almost invariably, those driven by quantity and customer, those not driven by quantity—some of which are fixed and some of which are driven by customers or products or both. Such additional costs may include accounts receivable and inventory carrying costs, for example, and may encompass other costs of goods sold, physical SG&A costs, and non-physical SG&A costs.

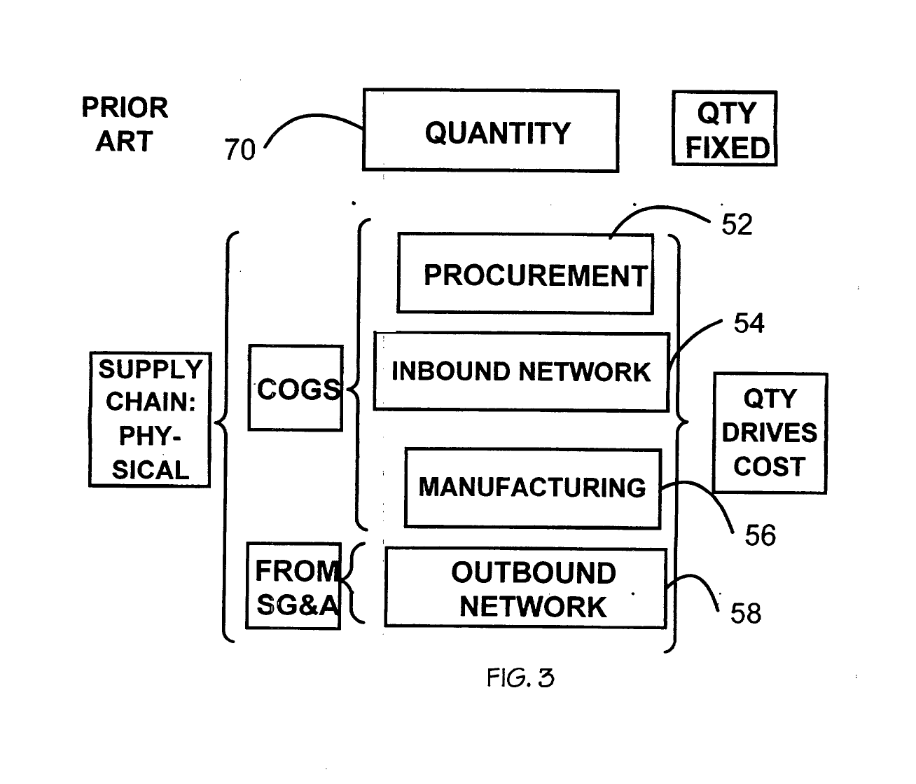

FIG. 3 shows a diagrammatic view of a model structure for supply chain network design according to the prior art. Note that the prior art model structure of FIG. 3 is based on quantity 70, and assumes a fixed level of demand. The prior art model structure of FIG. 3 includes data representative of only costs of goods sold and physical SG&A costs. Specifically, the prior art structure of FIG. 3 only includes procurement costs 52, inbound network costs 54, manufacturing costs 56, and outbound network costs 58. These costs are also referred to as supply chain physical costs—all of which are driven by quantity including product almost invariably and sometimes in concert with customer.

It will be appreciated by those of skill in the art that the model structure of FIG. 2 differs from the prior art structure of FIG. 3 by inclusion of data representative of non-physical SG&A costs. Not all of the costs of the model structure of the present invention are driven by quantity. Some are not driven by quantity, and others, referred to as demand drivers, actually drive quantity, as previously described herein. Thus, the model of the present invention accommodates demand. The present invention is built to reflect, not only the demand's volume relationship to the physical costs in the p/l (i.e., supply chain costs), but also the non-physical costs as well. Creating a volume relationship for these costs will be referred to herein as “capacitating” these non-physical costs, and the plotted relationship of volume to these costs is referred to herein as “capacitation curves” or “capacitation cost curves”. Further, specifically for the demand driver costs, the relationship of demand to demand drivers is referred to herein as “response curves” or “response cost curves”. According to the present invention, demand is designed to the physical network as opposed to prior art network design systems where the physical network is designed to the demand.

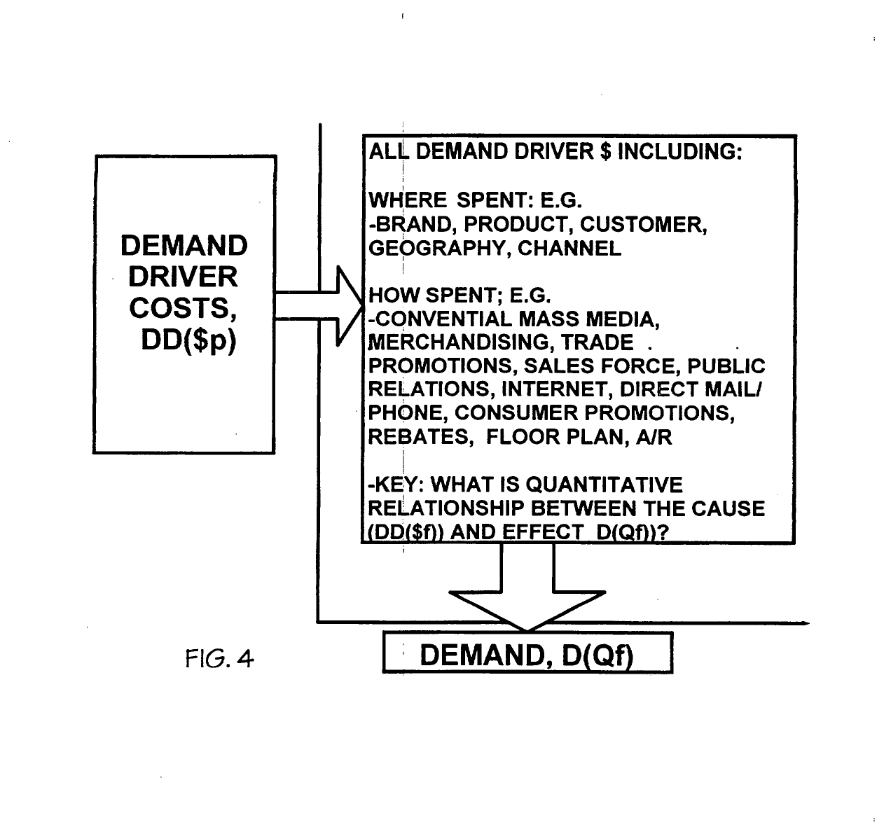

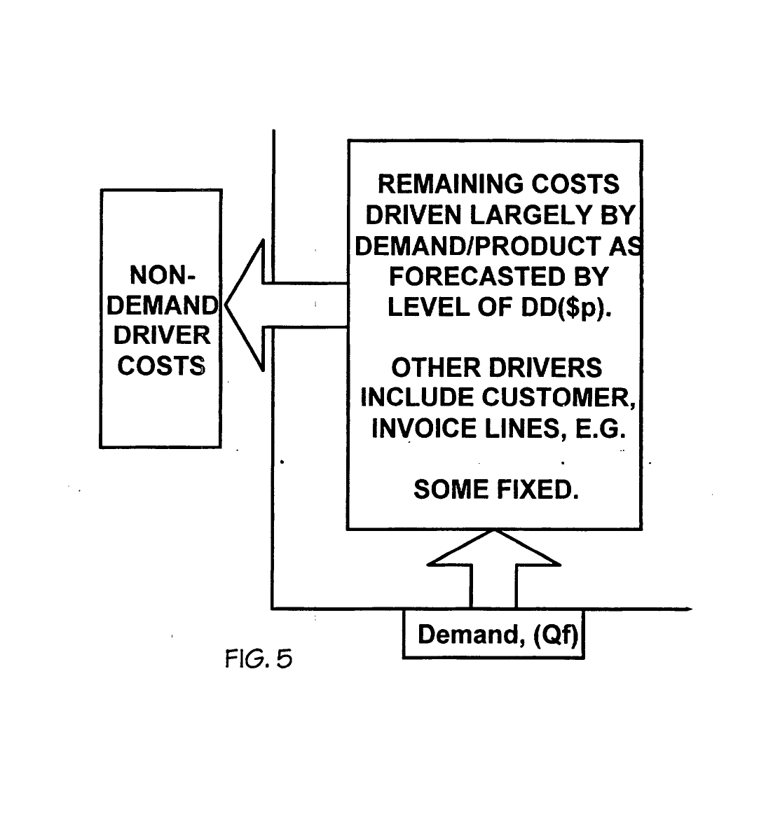

FIG. 4 shows a block diagram of the relationship of demand drivers and demand according to one embodiment of the present invention. FIG. 5 shows a block diagram of the relationship of demand to the non-demand driver costs according to one embodiment of the present invention. Collectively, FIG. 4 and FIG. 5 illustrate how the system and method of the present invention model demand. As shown in FIG. 4, demand drivers, DD($f), effect demand, D(Qf). To determine the quantitative effect of demand drivers on demand, the system and method of the present invention examine where demand drivers are spent, such as on a brand, product, customer, channel, geography, corporate, etc. The present invention also examines how demand drivers are spent. What is the marketing mix of demand driver expenditures? Examples of a marketing mix may include conventional mass media, merchandising, trade promotions, sales force, public relations, internet, direct mail, direct phone, consumer promotions, etc.

As shown in FIG. 5, the system and method of the present invention also examine the effect of demand on non-demand driver costs. Such relationship accommodates all other costs in the profit and loss statement, including those that are driven by demand. Such costs that are driven by demand may include the cost of the product's raw material, the cost of transporting the raw material to the manufacturing plant, the cost of transforming the raw material to the finished product, etc., for example.

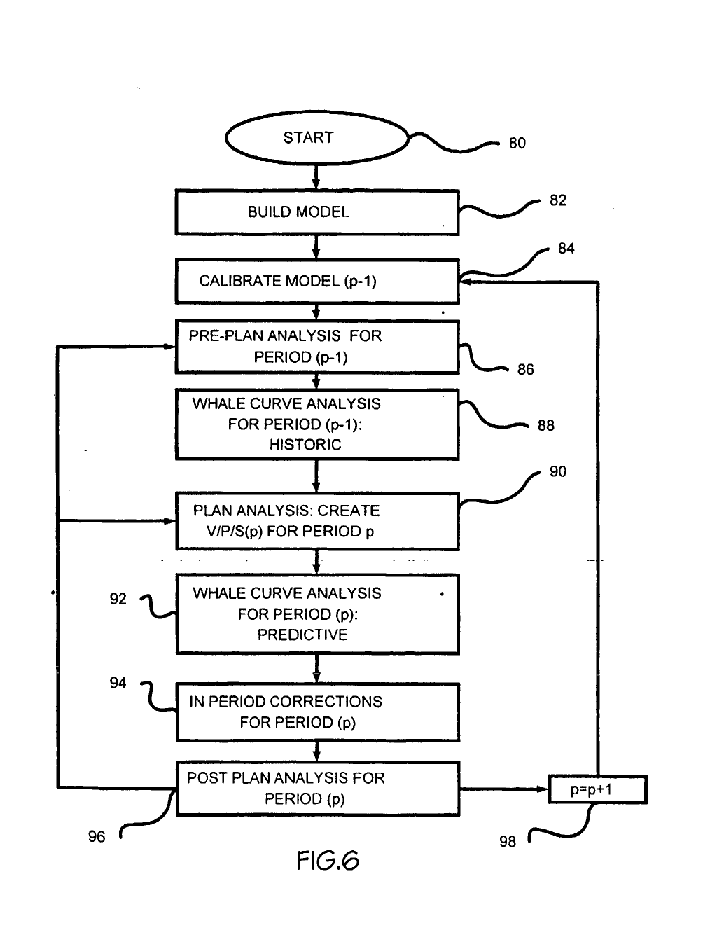

Referring now to FIG. 6, there is shown a flow chart of one embodiment of the method according to the present invention. According to this embodiment, the method begins at step start 80. At build model step 82, the system is built using data for the previous period, as is discussed in greater detail herein. The term “period” refers to a time period over which a user desires to use the system and method of the present invention. Perhaps the most common period will be one year in duration, but other time frames are contemplated to be within the scope of the invention as is described in greater detail herein. At calibrate model (p−1) step 84, the model built in step 82 is calibrated by applying data from the previous period to ascertain whether the model build represents the previous period to an acceptable level of accuracy.

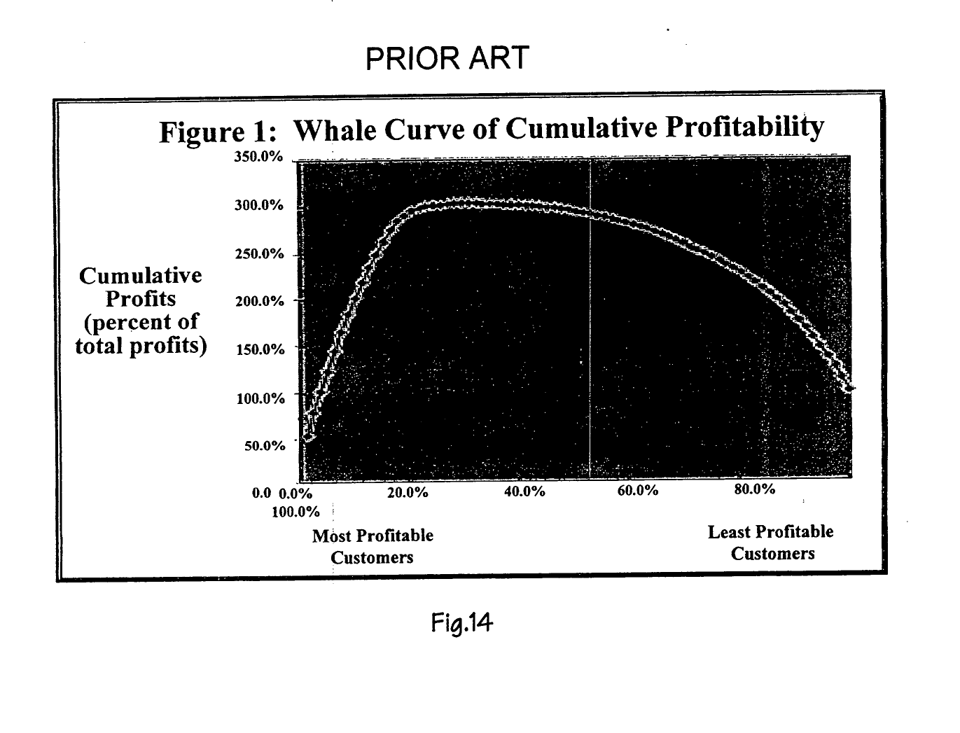

At pre-plan analysis step 86, the model built in build model step 82 and calibrated in step 84 is used to analyze the scenarios developed in step 86. As an optional step, historic whale curve analysis for the previous period (p−1), such as is taught by Kaplan in Customer Profitability Measurement and Management, Harvard Business School, May 2001, may be performed in whale curve analysis step 88. Such whale curve analysis looks at cumulative profitability, i.e., cumulative profits as it relates to customers—ranging from the most profitable customers to the least profitable customers. An example of a whale curve is illustrated herein on FIG. 14. Additional details are available in Cost and Effect, Kaplan and Cooper, Harvard Business School Press, 1998, Chapters 9 and 10.

By completion of pre-plan analysis step 86, and, if desired, optional historic whale curve step 88, a three dimensional solution space is developed for the previous period. This three dimensional solution space comprises the volume/profit/scenario space for the previous year, and is designated herein as V/P/S(p−1). At plan analysis step 90, plan analysis is made to create a three dimensional solution space for the present period, namely, V/P/S(p). The three dimensional solution space is volume/profit/scenario space for the present period, and is created as is described in greater detail herein.

After completion of plan analysis step 90, predictive whale curve analysis for period p may optionally be performed at step 92. In predictive whale curve analysis step 92, the user may perform whale curve analysis to assess the predictive profitability for the present period. At the completion of plan analysis step 90, and optionally, predictive whale curve analysis step 92, the method may include in-period correction step 94. At in-period correction step 94, the model built for the present period is corrected for significant changes that occur during the present period as is described in greater detail herein. While in-period correction step 94 is optional, as explained in greater detail herein, it is desirable if significant changes due occur during the present period.

Continuing with the embodiment of the method of the present invention illustrated in FIG. 6, post plan variance analysis step 96 is performed. During post plan variance analysis step 96, analysis is made of the results of the model applied to the present period versus the actual performance of the present period, and is described in greater detail herein. In this manner, the accuracy of the model can be improved prior to application for the next period.

At step 98, the period is incremented for application of the model to the next time frame. Upon incrementing the period at step 98, the system returns to calibrate model (p−1) step 84 for the period just completed.

It will be appreciated by those of skill in the art that the method of the present invention results in continued improvement in the model. The model evolves by accommodating changes that occur during any period and analysis of the results at the end of a period. Thus, the present invention avoids the shortcomings associated a static model, and it continually evolves to develop and maintain accuracy, and actively involves sales and marketing personnel in the planning process.

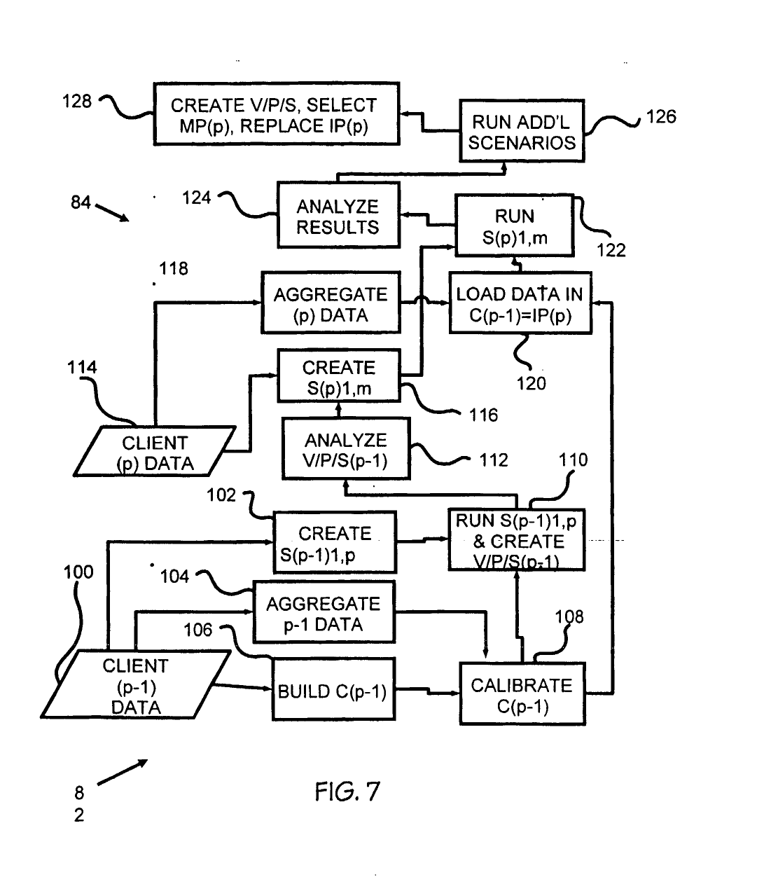

FIG. 7 shows a flow chart of the calibration and building of the model according to one embodiment of the present invention. The flow chart of FIG. 7 shows further detail with regard to build model step 82, calibrate step 84, pre-plan analysis step 86, and plan analysis step 90 of FIG. 6. At step 100, actual data, including profit/loss, from the previous period (p−1) is entered into the system. Referring to FIG. 1, such actual data is collected in database(s) 34 of computer 30, and is retrieved either from external system(s) 36 or first, second, or third workstations 40, 42, or 44, respectively. The data collected from the previous year includes physical costs, such as the costs of goods sold, as well as non-physical SG&A costs, such as sales and marketing expenses.

After actual data is collected from the previous period at step 100, processor(s) 32 of computer 30 proceed in step 106 to design/build calibration model C(p−1), to aggregate the data from the previous period in step 104, as appropriate, and to create analysis scenario(s) S(p−1)1,n for the previous period in step 102. To build calibration model C(p−1), processor(s) 32 of computer 30 use supply chain network design as is well-known in the art. Examples of such supply chain network design software include Supply Chain Strategist, available from i2 in Dallas, Tex., or SSA Supply Chain Design, available from SSA Global of Chicago, Ill. The objective of step 106 is to develop a model in the software that accurately reflects the company's annual operations, as they actually occurred in the last period.

As with traditional network design models, certain input data for the model (e.g., customers, products) collected in step 100 must be aggregated from the transaction detail so the computer run time to get a solution for the model is not excessively long. According to the method of the embodiment of FIG. 7, such aggregation is performed at step 104 by processor(s) 32 of computer 30.

As with all such traditional models, it is essential that this aggregation be done in such a way that the individual customers contained in any given aggregation consume the physical resources of the model in a similar fashion. For example, all customers within an aggregation might order and receive orders in the same manner (e.g., full truckloads), the physical resources in the warehouse for picking/packing/shipping, transportation and delivery could be consumed similarly. What needs to be stressed in this situation, however, is that in addition to the requirement that the physical resources be consumed similarly, the same requirement holds for the non-physical resources (e.g., the accounts receivables department). Also, for the most robust pre-plan analysis and profit profile analysis, as is discussed in greater detail herein, capacitation curves for these non-physical costs should be defined in step 104 for at least a ±20% volume range around the calibration volumes. Definition of the capacitation curves for the non-physical costs should be so defined because analyses will be based on optimization of the calibration model with different scenarios, and the solution quantities will most likely be greater or less than the volumes used for calibration, specifically, the actuals for the previous period (p−1).

For companies who are already performing strategic activity-based management as described in the Background section above, insights into proper aggregation of customers and products for these non-physical costs could be obtained from the results of the strategic ABM process. One way to proceed for such aggregation would be:
1. Eliminate all products and customers in the lowest percentile of revenue (e.g., 1%).
2. Eliminate fixed costs from the activity-based management database.
3. Eliminate sales/marketing costs.
4. Create a profit profile for products with the costs left in the database.
5. Create some number, e.g., 20, categories of products, from most profitable to least profitable. Inspect these products, and, if the products have similar physical cost characteristics, such characteristics could indicate that aggregation of such products is appropriate.
6. Create a profit profile for customers with the costs left in the database.
7. Create some number, e.g., 20, categories of customers, from most profitable to least profitable. Inspect these customers, and, if the customers have similar physical costs characteristics, such characteristics could indicate that aggregation of such customers is appropriate.

Another way to aggregate would be to use the product and customer grouping/categorizing functionality that at least one of the activity-based management software packages, such as Profit Analyzer, available from Acorn Systems of Houston, Tex., provides to accomplish the aggregation required for the present invention in step 104.

After step 106 is completed to design/build calibration model C(p−1), the C(p−1) model is calibrated in step 108. To calibrate the C(p−1) model, data from the previous period collected in step 100 and aggregated data for the previous period as created in step 104 are loaded into the C(p−1) model at step 108. Once the model has been designed/built as in step 106, the necessary data requirements are known and the places where the data reside identified—typically either transaction systems themselves or transaction reporting systems in step 100. In step 104, which is frequently referred to as a “supply chain decision database” (see Shapiro Chapter 6 for details), this database is created using any of a variety of software offerings available, such as Access available from Microsoft Corporation of Redmond, Wash., or Oracle available from Oracle Corporation of Redwood City, Calif. In this database, the raw data is analyzed for accuracy, aggregated as appropriate, and put into the right format for importing into the model. The model data is then imported into the mode at step 108, typically as a flat file using native functions in the model application software.

Calibration to within an acceptable percentage, such as ≦1%, of the actual costs is achieved by forcing the volumes from the previous period p−1. Calibration for the present model is tighter than that normally required for a network design model. This tighter calibration is desired for a variety of reasons, including the accuracy of the object function (e.g., profit, economic value, etc.) the model uses and the associated business decisions that will be made on the basis of the results.

It will be appreciated that once a calibration model C(p−1) is built for period p−1, there is no need to build the model, or another model, again, as the model, it already exists. The model structure is that of the maximized profit planning model as it exits at the end of the period. Thus, as shown in FIG. 6, design/build model step 82 is not repeated for subsequent time frames. Instead, as is described in greater detail herein, while the basis structure stays the same, the model's capacitation and response cost curves continue to evolve during each time period.

Referring again to FIG. 7, in step 102, analysis scenarios for the previous period, namely, S(p−1)1,n, are created. Scenarios are “what if” conditions created, most likely by senior management, and, particularly, both those having knowledge and experience in sales, marketing, and finance. These p−1 scenarios are intended to allow senior management to explore how the previous period would have performed under different assumptions than those used in creating the previous period (p−1) plan, originally, thereby allowing for a more informed set of scenarios to be defined for period p, S(p)1,m. The results of the scenarios are plotted graphically, creating the volume/profit/scenario solution space (V/P/S(p−1)), strictly for the purpose of ease of comparison.

Some examples of scenarios that may be created include:
1. Optimize C(p−1), such as by removing the constraint on the model that the solution had to be the actual volumes from the previous period p−1. This allows the solver to create a solution of only those volumes that maximize profit. The solver used according to the present invention is referred to herein and in the claims as “optimization techniques”. The optimization techniques comprise a mixture of linear and integer mathematical programming solution techniques. The use of optimization techniques permits for the generation of an optimal solution, and is executed by processor(s) 32 of computer 30 (See FIG. 1).
2. Fixed manufacturing capacity (product/brand)+5% demand (zip/channel), zero baseline demand forced.
3. Fixed manufacturing capacity (product/brand)+10% demand (zip/channel), zero baseline demand forced.
4. Fixed manufacturing capacity (product/brand)+5% demand (zip/channel), 95% baseline demand forced.
5. Fixed manufacturing capacity (product/brand)+10% demand (zip/channel), 90% baseline demand forced.
6. Baseline manufacturing capacity as minimum (product/brand)+10% demand (zip/channel) and zero baseline demand forced.
7. Baseline manufacturing capacity as minimum (product/brand)+10% demand (zip/channel) and baseline demand forced.
8. Other objective functions, with appropriate model modifications (e.g., economic value).
9. As appropriate, families of “response curves”, as discussed in greater detail herein, most likely will be created, and scenarios run to analyze their impact in preparation for the next step in the methodology of the present invention. After completion of application of the model to at least one period, important input to these scenarios will come from the prior period's post-plan variance analysis.
10. Step 116 of FIG. 7 sets forth other possible scenarios.

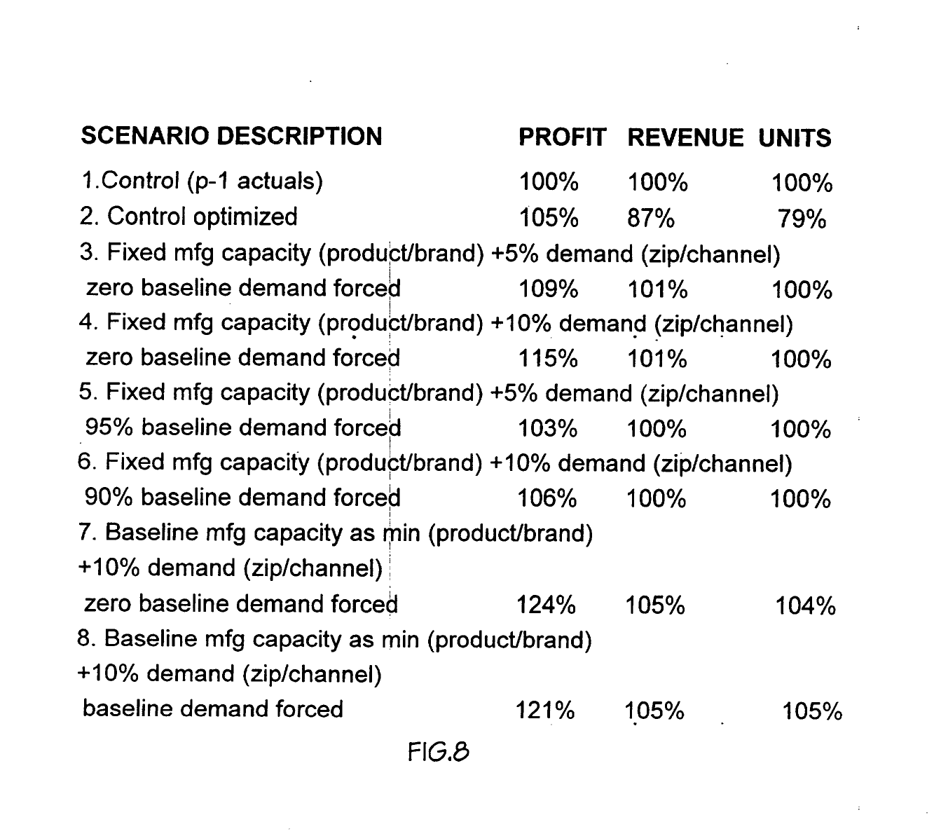

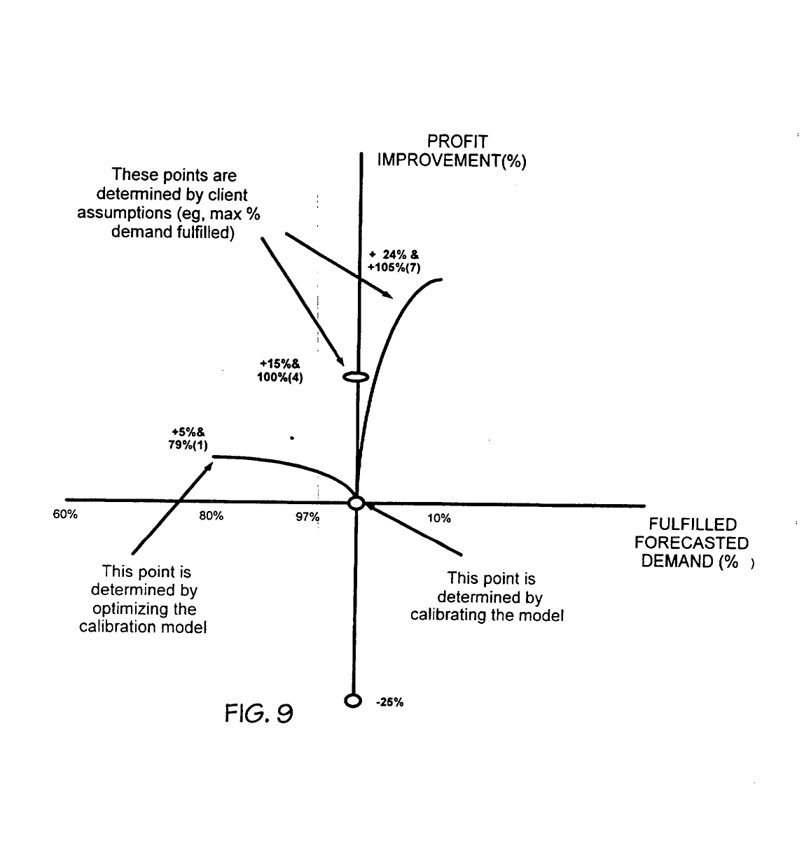

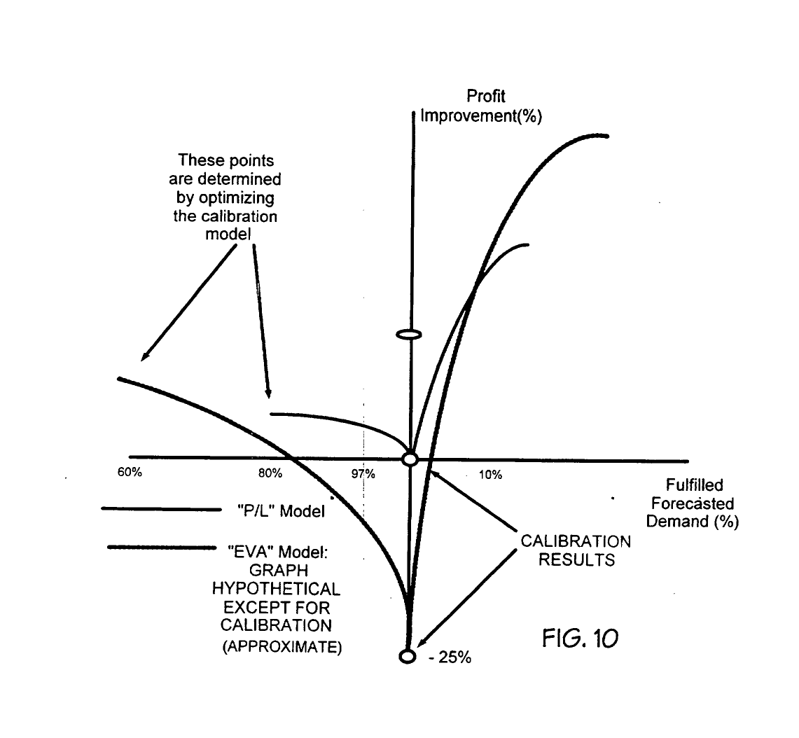

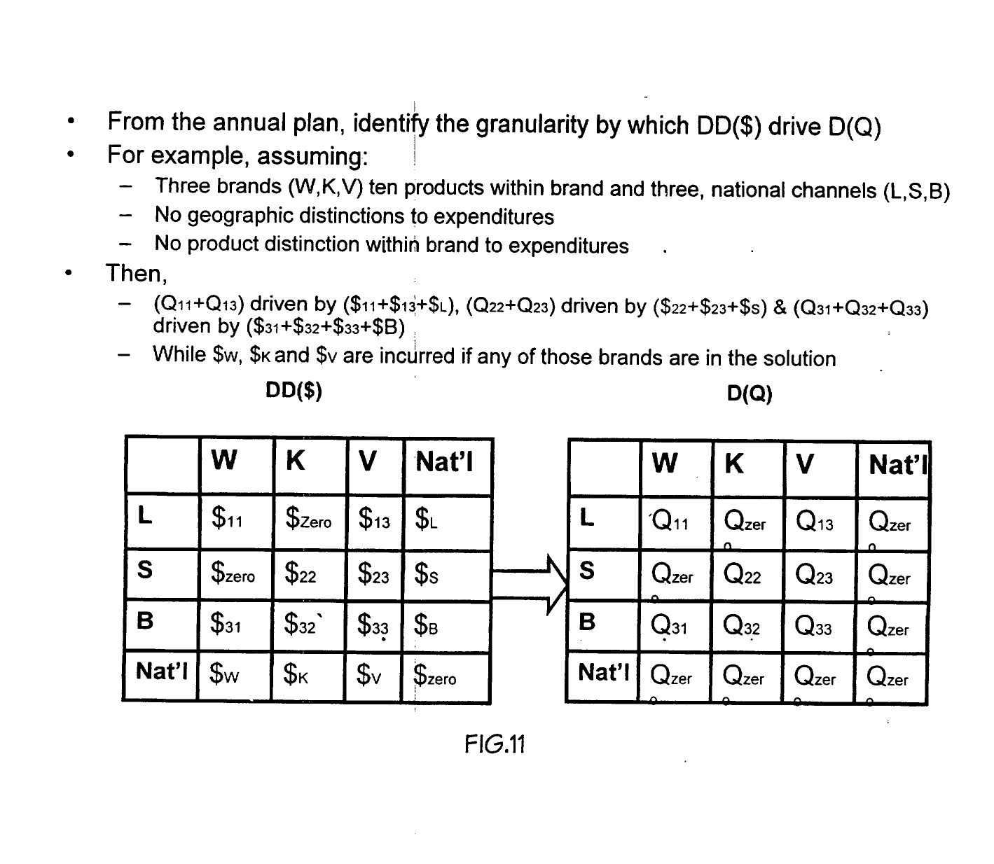

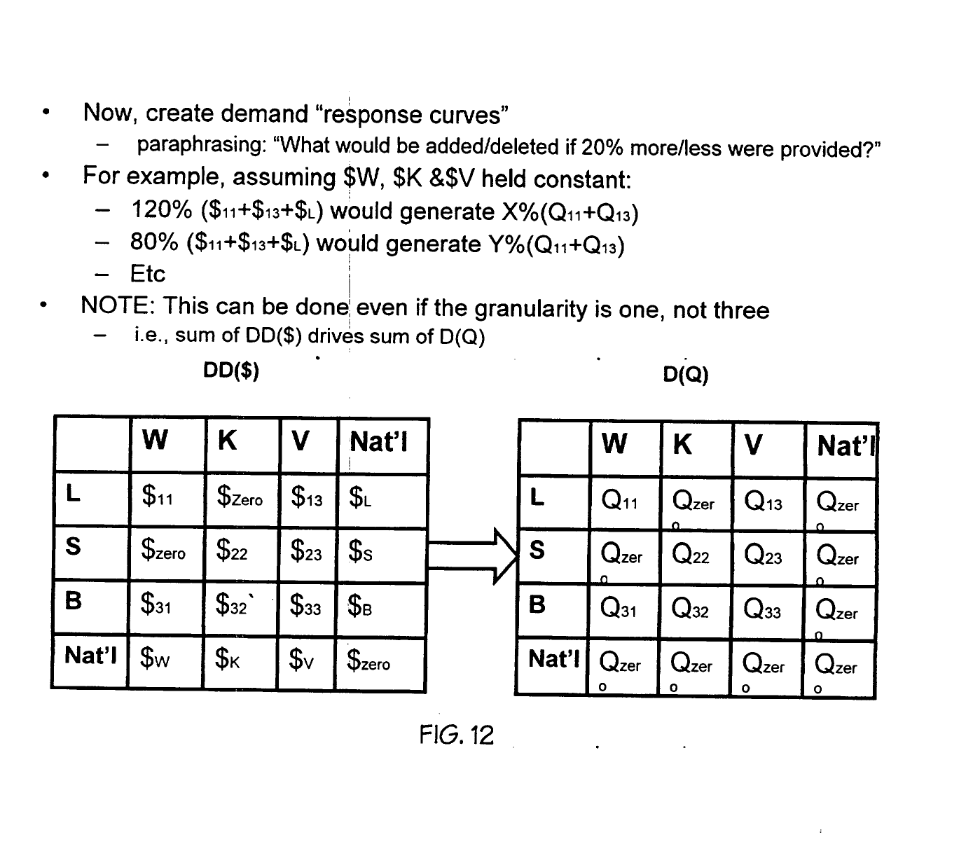

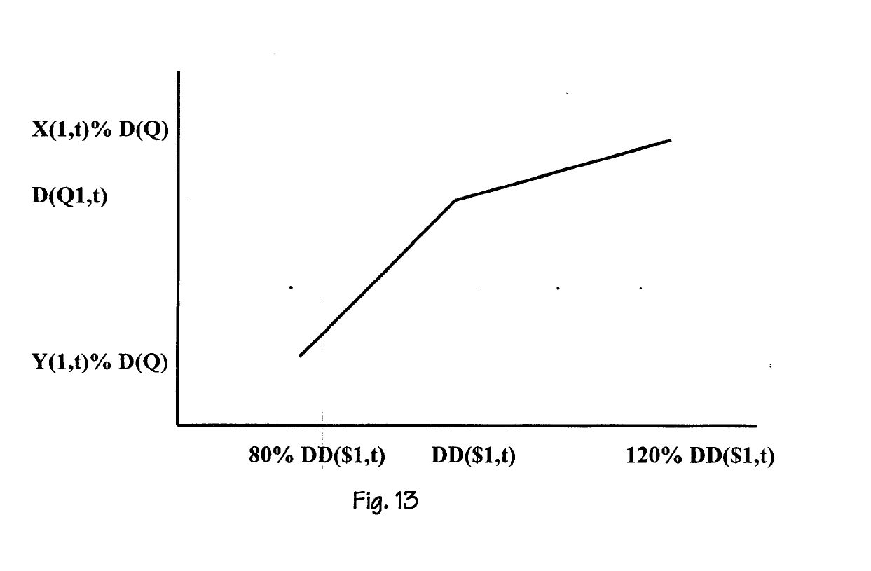

For more discussion related to the creation and use of scenarios, consider FIG. 8, FIG. 9, FIG. 10, FIG. 11, FIG. 12, and FIG. 13. FIG. 8 shows a table of examples of scenario used in one embodiment of the method of the present invention. Specifically, FIG. 8 shows the examples of scenarios 1-7 above, together with the scenario of the use of C(p−1) actuals—the calibration model. Note that profit, revenue, and units are specified for each of the seven scenarios listed. For the scenario using calibration model C(p−1) actuals, the profit, revenue, and units each represent 100%, i.e., represent the actual profit, revenue, and units for the previous period.

Referring now to FIG. 9, there is shown a graph of the results of the eight scenarios of FIG. 8, including calibration using profit maximization according to one embodiment of the present invention. These graphical representations are illustrative, and show the relation of profit improvement to fulfilled forecasted demand percentage. The profit maximization analysis of FIG. 9 is determined by imposing and/or relaxing the assumptions described in scenarios 1-7. The intersection or origin of the profit/volume plot is the calibration model results. Results from scenario 4 and 7 are also included on FIG. 9 for illustrative purposes.

FIG. 10 shows, illustratively, a graph of the results or economic value maximization analysis according to one embodiment of the present invention. In this embodiment, the calibration model is at 100% and an approximate-25% profit. The economic value maximization analysis of FIG. 10 is determined by adding to the costs of the profit maximization analysis, the capital carrying costs for accounts receivables and inventory.

FIG. 11 shows a matrix of an example of the relationship of demand drivers to demand according to the present invention. As previously discussed in association with FIG. 4, the relationships of demand driver expenses to demand are examined by the present invention. In performing this examination, from the annual plan, identify the granularity by which demand driver expenses drive demand. First, those costs are selected that are the primary drivers of demand (e.g., sales, marketing, or both). There are a variety of ways to determine the costs required to generate a given demand or achieve a given forecast. One technique used to determine the costs required is called “objective and task”. Demand D(Q) is the objective and demand driver expenditures DD($) are the expenditures required to perform the tasks required to achieve the objective.

It is important to point out that what enables the “task and objective” process to work is the sales, marketing, and financial executives' professional experience. These types of persons are the ones who synthesize and integrate all the other myriad variables (e.g., new products, competition, price, economic environment, etc.) that create or sustain demand besides the primary one of demand driver expenditures.

Causality is key, as no allocation is permitted so it is likely the granularity, initially, will be poor of demand driver costs versus demand. What this means is that the product/brand and brand/customer matrix of demand D(Q) will have many, many more cells populated than the same matrix for the costs that are the demand driver costs DD($). Ratios of thousands to one would not be unlikely initially.

In the example of FIG. 1, it is assumed that there are three brands, designated by W, K, and V, ten products with a brand, and three channel, designated by L, S, and B, through which brands W, K, and V are distributed. It is also assumed that there are no geographic distinctions to expenditures, and no product distinctions within a brand to expenditures. There are also demand driver brand expenditures made independent of the channel, and which as identified as “Nat'l”.

In the example of FIG. 11, demand through channel L consists of demand for brand W through channel L, Q₁₁, and demand for brand V, Q₁₃, through channel L. Thus, the total demand for channel L is driven by the demand driver expenditures for (Q₁₁+Q₁₃), namely, ($₁₁+$₁₃+$_{L}). Demand through channel S consists of demand for brand K through channel S, Q₂₂, and demand for brand V in channel S, Q₂₃. Thus, the total demand for channel S is driven by the demand driver expenditures for (Q₂₂+Q₂₃), namely, ($₂₂+$₂₃+$_{S}). Demand for channel B consists of demand for brand W in channel B, Q₃₁, demand for brand K in channel B, Q₃₂, and demand for brand V in channel B, Q₃₃. Thus, the total demand for channel B is driven by the demand driver expenditures for (Q₃₁+Q₃₂+Q₃₃), namely, ($₃₁+$₃₂+$₃₃+$_{B}). Also, national demand driver expenditures for brands W, K, and V, designated as $_{W}, $_{K}, and $_{V}, are incurred if brand W, K, or V, respectively, are in the solution.

FIG. 12 shows a matrix of the example of FIG. 11 with notes regarding the development of demand response curves according to the present invention. The notes relate to the development of scenarios under the system and method of the present invention. As previously described, scenarios are likely to be developed by those persons have selling, marketing, and/or finance knowledge as related to the company for which the analysis is being made. The example set forth in FIG. 12 considers the “what if” scenarios of “What would be added/deleted if 20% more demand driver expenditures were provided?”, and “What would be added/deleted if 20% less demand driver expenditures were provided?”. With regard to 20% more demand driver expenditures available for channel L, the question being analyzed and answered by such persons would be, 120% of ($₁₁+$₁₃+$_{L}) yields what percentage, X%, of (Q₁₁+Q₁₃)? With regard to 20% less demand driver expenditures available for channel L, the question being analyzed and answered by such persons would be, 80% of ($₁₁+$₁₃+$_{L}) yields what percentage, Y%, of (Q₁₁30 Q₁₃)? Similar questions would be asked with regard to channels S and B. Because there does not exist a national demand for brands W, K, and V, no such question would be asked with regard to Nat'l demand driver expenditures $_{W}, $_{K}, or $_{V}.

There are different ways to determine the percentages used in development of the scenarios. One way is to focus on the total of all demand driver expenditures DD($). These demand driver expenditures DD($) include, for example, advertising, sales promotion, public relations and publicity, personal selling, and direct marketing expenditures. If, on the other hand, one of the driver costs far outweighs the other(s), (e.g., sales) the impact of reducing or increasing that specific cost would be assessed and then the other demand driver costs determined by whatever mechanism makes the most sense in light of the first (e.g., held constant, ratioed, etc.). It is important to note that, however determined, these demand driver costs-as-planned need to be recorded, as they will be important for post-plan variance analysis performed according to the present invention.

Whatever approach is used, it is important to point out, as with the D(Q) and DD($) numbers themselves, that these X and Y percentages are a reflection of the demand drivers' executives experience and are being used in lieu of an analytical determination of the same numbers. This dependence on the executives' experience is necessary because the number of variables that they are synthesizing as they make their original DD($) and D(Q) judgments and their DD($)±20% and D(Q) judgments can not, for practical purposes, be quantitatively modeled. Also, while the examples discussed herein have used a ±20% variation for development of the scenarios, other percentage variations may be used to develop the scenarios and be within the scope of the present invention, and more than one set of percentage variations may also be used for development of more scenarios and be within the scope of the present invention.

FIG. 13 shows a graph of an example of a demand response curve according to the present invention. Response curves of the present invention are determined by development of scenarios, and reflect the relationship of variations in demand driver expenditures to demand. In the example of FIG. 13, the response curve is shown as having three data points—one representative of 100% of demand driver expenditures and 100% of demand (the intersection of demand driver expenditures DD($1,n) and demand D(Q1,n)), another representative of 120% of demand driver expenditures (the intersection of 120% DD($1,n) and X(1,n)% D(Q)), and another representative of 80% of demand driver expenditures (the intersection of 80% DD($1,n) and Y(1,n)% D(Q)). Such a response curve is representative of the relationship between demand driver expenditures and demand, and, as is discussed in greater detail herein, are modified and improved as data from subsequent periods is collected and analyzed.

Referring again to FIG. 7, at step 110, the scenarios for analyzing the previous period to inform period p's plan, S(p−1)1,n, created in step 102 are loaded into calibration model C(p−1) created in step 108, and the results of running the scenarios are used to create three dimensional solution space V/P/S(p−1). The loading of scenarios into C(p−1) can be accomplished by the processor(s) 32 of computer 30 (see FIG. 1). The data input requirements for the scenarios are typically modest enough that the data entry is done using native functionality in the modeling software. Otherwise, it can be input as described in step 108, calibration.

FIG. 14 shows a graph of a whale curve according to the prior art. As an optional step (see step 88 of FIG. 6), before proceeding to the next time frame (period), a user may perform a whale curve analyses. Whale curve analyses performed using the present invention have a variety of advantages over the traditional whale curves that are foundational to the strategic activity-based management process. If the company is already using prior art whale curve analyses, entirely new insights into the profitability of inter-relationships of customers, products, channels, geographies, etc. are possible with whale curve analyses of the present invention. This is because the present invention whale curves are developed with optimization techniques and allow more than one criteria, for example, product and customer, to be used with profiling profit. These new whale curves permit confirmation or alteration of action plans developed on the basis of prior art whale curves. If the company is not presently using prior art whale curves, then whale curves developed according to the present invention will enable profit improvement plans to be developed.

Returning now to FIG. 5, at step 112, the solution space V/P/S(p−1) is analyzed. The solution space is nothing more than a graphical representation of the results of the scenarios S(p−1)1,n. The analysis consists of the senior management reviewing the results in the context of the underlying assumptions, and deciding whether any of the previous year p−1 scenarios should be included in the present period p scenarios and whether any of the currently proposed period p scenarios should be modified or eliminated.

After completion of step 112 where the solution space V/P/S(p−1) is analyzed, the steps of calibrate/build model 82, pre-plan analysis 84, and, optionally, whale curve analysis 86, of FIG. 6 have been completed. Now, the method of the present invention proceeds to perform plan analysis step 88 (see FIG. 6). At step 114, planning data for the present period is collected and stored on database(s) 34 of computer 30 (see FIG. 1). As was the case for collection of data from the previous period in step 100, the planning data may be provided from external system(s) 36 or from workstations 40, 42, or 44 (see FIG. 1). Planning data for the present period is aggregated, as appropriate and as required, in step 118. Also, scenarios for the present period, S(p)1,m, are developed in step 116, using the same or similar procedures as used in development of scenarios for the previous period in step 102. Possible scenarios include:
1. Demand: equally likely range, acknowledging demand is not deterministic.
2. Demand as function of the causal demand driver costs, creating families of response curves. Key will be input as developed in the post-plan variance analysis for the prior period.
3. Other object functions than profit including economic value, shareholder value, etc.
4. Different pricing assumptions.
6. Delay of a new product(s).
7. With appropriate constraints: plus and minus
   Manufacturing capacity
   Minimum/maximum demand for a channel or customer
   Maximum demand driver expenditures by total, brand, channel, customer, etc.
   Profit profiles, as required.
8. Alternative sources of supply (e.g., plants, distribution centers, warehouses) for given customers.
9. “What if” scenarios can also be defined. For example, profit impact of more advertising vs. more stores, or trade-offs between better service and lower prices.

At step 120, the aggregated data for the present period created in step 118 are loaded into calibration model C(p−1) for the previous period to create a model for the present period, IP(p). As previously discussed, this calibration model for all periods after the first period will simply be the MP model calibrated with actual results of the MP model's period. To create present period model IP(p), the starting point is the annual plan developed by traditional methods and referred to as the planning data of step 114. The annual plan for the present period, referred to herein as TP(p), has a variety of qualitative assumptions and associated quantitative data. In TP(p), there are a variety of qualitative/quantitative and exogenous/endogenous assumptions made and associated data developed that are used to develop the quantitative data for the IP(p) model. The quantitative data for the IP(p) model includes prices, capacitation cost curves, response cost curves, demand, constraints, etc.

Using the forecasts, prices, associated budgets, constraints, etc. contained in TP(p), the calibration model C(p−1) is updated, creating the IP(p) model. Update of the calibration model C(p−1) with TP(p) data is accomplished in the same manner than the calibration model was initially updated if the volume of data requires it. Otherwise, it can be updated as scenarios are updated using functionality of the modeling software. For the first period, as appropriate, IP(p) model costs that were not capacitated in C(p−1) model are now capacitated with no allocation because, though the IP(p) model forecasted quantities are known, the solution quantities of the various scenarios that will be run, are not.

Reiterating a point made above, it is essential to capture all customer-driven costs at the appropriate level of detail including demand driver expenditures such as expenditures on brands, products, geography and channels, particularly significant individual customers, other customer unique costs like financial (e.g., floor plan, accounts receivable terms, etc.) and fulfillment nuances (e.g., order frequency, less than truck load vs. truck load, etc.). These costs must be capacitated sufficiently to span the volume ranges over which the manufacturing activity is to be analyzed and profitability profile analyses conducted.

In step 122, the scenarios for the present period, S(p)1,m, developed in step 116 are run in present period model IP(p). To run the scenarios in step 122, the same methodology used previously in step 110 may be used.

In step 124, each scenario's results are then analyzed to address key issues. This step 124 is accomplished by senior management analysis as described earlier herein. Some key issues are addressed include (a) Can the “redesigned” demand be accomplished by realigning demand driver activities as called out by the solution? (b) Is the redesigned demand plausible, given forecasting techniques? (c) If the redesign demand is not plausible, the scenario is removed from consideration. Based on the results of the analysis performed in step 124, additional scenarios are defined, run and analyzed as required in step 126.

In step 128, a preferred solution space V/P/S(p) is created using the same methodology described herein for creation of V/P/S(p−1). The objective of this step 128 is to define the V/P/S(p) solution space as robustly and credibly as possible, including looking for scenarios with different volumes and profit (x dimension and y dimension) and for scenarios (z dimension) with different assumptions and constraints that generate similar profit and/or volume. The reason is that, if profit is stable for a variety of assumptions, the likelihood of achieving the planned profit is increased—in other words, a “robust” solution is created. Of the volumes, profits, and scenarios evaluated, the demand redesign is chosen that best accomplishes company's business objectives (e.g., market share, profit, risk, etc). The key is selecting the demand redesign relates to where within the V/P/S solution space that the company desires to operate. The scenario that best achieves the company's business objectives becomes the new annual plan, i.e., the MP(p) model for maximum profit plan. The MP(p) model for maximum profit plan includes the associated budgets that are, simply, the solution quantities' intercepts on the various cost curves. These budgets are, thus, transformed from controlling as they were in IP(p) model to funding/enabling the company's attainment of the maximum profit identified in MP(p). Obviously, the intercept of the solution quantities on the response curves are the demand driver budgets, accomplishing the first use or objective of the present invention to maximize planned profit by integrating sales and marketing planning and budgeting within the current supply chain, and achieving the rest of the cost curves, achieving the budgets for the remainder of the plan, and accomplishing the simultaneous development of a company-wide activity-based budget.

At this point after selection of MP(p), the company may desire to perform analysis by taking the original set of (t) demand drivers and forecasted demand data contained in the IP(p) model and plot the sets of data as a scatter diagram. Theoretically, there should be no correlation of the data; however, because of “halo” effects there may be some relationship. The same type of scatter diagram could be created showing the planned demand drivers and demand data sets contained in the MP(p) model. Again, as with the IP(p) model data, there is no a priori assumption about a relationship between the data; however, the possibility of a relationship should be examined and discussed. Analytics might also be employed to assess relationships between the data (e.g., regression).

The objective of such analysis is to enhance the marketing, sales, and/or finance executives' understanding of how the company's markets respond to marketing efforts as embodied in their sales and marketing expenditures when viewed traditionally (IP(p)) and with the added insight of profit optimization as provided by the present invention through MP(p). In this manner, the executives may improve their ability to create more accurate response cost curves over time.

Finally, using the MP(p) model, predictive profit profiles may be created—something heretofore not possible. The provision of predictive profit profiles give the company four significant advantages in pursing the profit opportunities:
1. Planned data, not historic data, is used to create the profiles. The use of planned data allows the company to formulate plans in an anticipatory fashion, and not reactively.
2. Profit profiles can be created from what ever combination of business realities or dimensions desired (e.g., product and customer).
3. The analyses can be company-wide.
4. Optimization techniques are used to develop the profiles.

Thus, the first step is to decide what profitability dimensions are to be analyzed and in what combinations: product, customer, channel, brand, etc. Then, assuming products and customers were chosen, constraints are introduced into the model for maximum number of customers and maximum number of products allowed in the solution at 1%-2% increments, down from 100% to the limits the costs have been capacitated. Previously, because it was not possible to profile simultaneously, for example, both products and customers, product profiles had unprofitable customers scattered throughout the profile and vice versa. Thus, the most effective, profit enhancing opportunities could not be identified and integrated actions designed and taken.

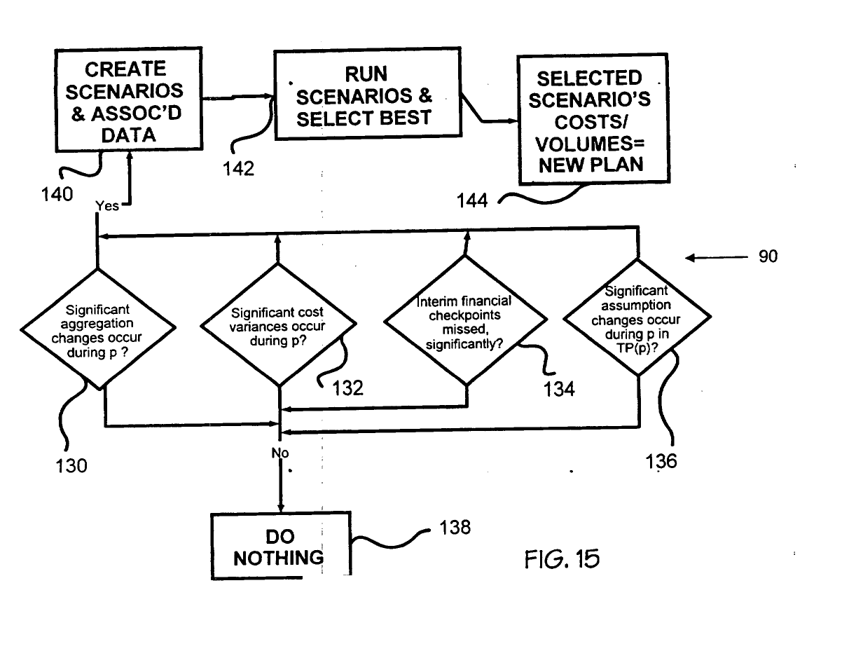

FIG. 15 shows a flow chart of adjustments made during a plan period according to one embodiment of the present invention. The flow chart of FIG. 15 corresponds to in-period corrections step 90 of the process illustrated in FIG. 6, and is used to make adjustments to the model in the event of any significant changes that occur during a period. Processor(s) 32 of computer 30 is(are) alerted by user of workstation 40, 42, or 44 (see FIG. 1) of any significant changes that have occurred during the period, or, for those changes than can be automatically monitored and evaluated, processor(s) 32 ascertain whether a significant change has occurred. Illustrated in FIG. 15 are four (4) such changes, namely, a check to see if there have been significant aggregation changes in step 130, significant costs variances in step 132, significant missing of interim financial checkpoints in step 134, and significant assumption changes in step 136. If there have been no such significant changes, the system proceeds to step 138 to do nothing. If, on the other hand, there have been significant changes as indicated by a “yes” answer to steps 130, 132, 134, and/or 136, the system proceeds to adjust the model for such changes.

Specifically, at step 140, scenario(s) are created relevant to the changes and associated revised model data (e.g., forecast) is(are) developed. Then, at step 142, the scenario(s) created in step 140 are run. The software used in this step 140 is to the same as that used to execute step 122 of FIG. 7. Then, the scenario(s) is(are) selected which best meets the company's business objectives. At step 144, the scenario selected in step 142 become the revised plan for the period, MP(p).

It will be appreciated by those of skill in the art that adjustments for significant changes are optional. However, without these updates, changes in the “real world” will go unrecorded in the MP(p) model that may render it inaccurate. Inaccuracy of the model will, in turn, cause profit to be lost and seriously compromise the accuracy of the variance analyses performed at the end of plan period, as is described in further detail herein. It should be kept in mind that there are no hard and fast rules that define whether an update is appropriate. It is for the company, on a case by case basis, to determine whether the change is significant enough to require an update.

Essentially, the update process itself is performed just as the original MP(p) model was developed. Once the appropriate change(s) has(have) been deemed significant to warrant an update in the MP(p) model, the changes are mapped in the appropriate of changes to the MP(p) model itself (e.g., modify the forecast), scenarios are defined, as appropriate, the MP(p) model will be re-run, as described in association with plan analysis step 90 of FIG. 6, and a revised MP(p) model selected and implemented.

It will be appreciated by those of skill in the art that there are a variety of situations that could arise that a company may determine require that the MP(p) model be updated, and not all are illustrated in FIG. 15. Some the possible situations are described below:
1. Assumption changes. It is possible that significant event(s) could occur that will invalidate one or more of the underlying assumptions (whether endogenous, exogenous, qualitative or quantitative) in the traditional model TP(p). Management could decide whether the event(s) were significant enough in terms of magnitude and duration to warrant changing the appropriate quantitative data in the MP(p) model (e.g., reduce the forecast). The following are some examples of the events that might occur. They are not illustrative of how the assumptions will be changed. The translation of events changing to data changing in the MP(p) model is inter-related and very case specific.
   a) Unanticipated competitive pricing actions;
   b) Significant unanticipated raw material cost increases, domestically or internationally (e.g., dollar strengthening more than planned, oil prices increasing more than planned);
   c) A delay in introducing a new product;
   d) Manufacturing volume disruptions due to unanticipated material shortages, equipment breakdowns, strikes, or the like; or
   e) Natural disasters.
2. Financial performance checkpoints not achieved. Many companies set interim (e.g., monthly or quarterly) plan performance targets (e.g., revenue, profit). It may be appropriate to update the MP(p) model if these checkpoints are not met. If these checkpoints include volumes as well, it may make sense to have developed the original MP(p) model at the planning horizon of the checkpoints instead of the one being used. Development at the planning horizon may be beneficial because the planning horizon is the one over which the demand driver costs DD($) are fixed, and if volumes associate with a checkpoint, then so may the demand driver costs DD($).
3. Variance analyses for costs other than DD($). Many companies conduct periodic (e.g., monthly) cost variance analyses during the plan period. If the variance analyses uncover significant enough variances in one or more of the costs modeled in MP(p), than an updated MP(p) may be appropriate.
4. Aggregation updates for products/customers. If the company has deployed strategic activity-based management, the company may using the results of strategic activity-based management to assist in the aggregation of customers and products as discussed earlier herein. If a company is so using strategic activity-based management, and the company is doing a monthly transaction analysis, then it is possible to validate the aggregations used in MP(p) each month. If significant changes occur in an aggregation, then MP(p) could be updated.

Additionally, it is important to note that, ultimately, an objective of the system and method of the present invention is that it become a more continuous process with a shorter planning horizon. All that is required to shorten the planning horizon for the creation of a new plan is to have developed demand and demand drivers at a time horizon shorter than the current (e.g., annual) time horizon. It is desired that, as the planning horizon is reduced, the system and method of the present invention be continuously updated at the end of each subperiod, such as a month, when significant changes of whatever origin that would cause the current plan, MP(p), to be invalid. To achieve this objective, the present invention should become a business process distinct from the annual planning process, while remaining appropriately synchronized with it. The ability of a company to adopt such a continuous planning process will, obviously, take time as cultures and systems will have to adapt.

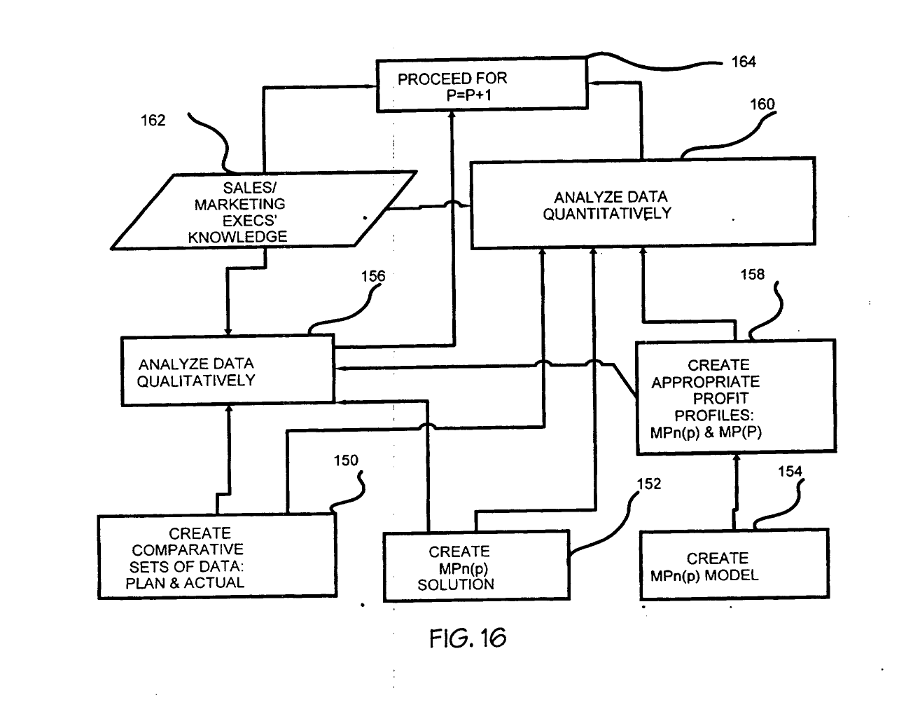

FIG. 16 shows a flow chart of post-plan variance analyses according to one embodiment of the present invention. All of the steps set forth in FIG. 16 may be performed by processor(s) 32 of computer 30 accessing and creating database(s) 34 of computer 30 (see FIG. 1). At the end of planning period, variance analyses of actual versus plan performance are made to continually improve the accuracy of the shape of all the cost curves (i.e., the shape of the costs as a function of volume) in the MP(p) model, whether capacitation cost curves are associated with the supply chain costs (i.e., physical costs), with SG&A costs (i.e., non-physical costs), or with the response cost curves (i.e., demand drivers).

As described above, many companies conduct monthly variance analyses using traditional accounting techniques. See Atkinson, at pages 507-516. These monthly analyses can be used to detect any shifts in the capacitation cost curves important enough to require updating MP(p). Therefore, for these companies, their capacitation cost curves are current.

For companies that do not already conduct monthly variance analyses, all that is required of the company to detect any shifts in the capacitation cost curves is performance of an annual variance analysis using traditional accounting techniques—something that would be done, in most cases, as a part of developing the traditional plan for next period (p+1), TP(p+1), anyway. It is important to note that these traditional variance analyses used in the present invention will be simpler than is typically the case because there are no “blended” costs to analyze. “Blended” costs are those created from a mix of fixed and variable costs. With the present invention, fixed costs are modeled separately from variable costs.
To the best of the applicant's knowledge, there exist no traditional accounting techniques for conducting variance analyses on the costs associated with response curves of the present invention. In traditional variance analyses, the first step performed is to normalize for volume. Then, efficiency (use) and price (rate) analyses are conducted. In the case of analysis of response curves, it is desired to determine what the problem(s) with the shape of the various DD($) and D(Q) curves (the response curves) was(were) to cause the actual demand to be at a variance with the planned.

As previously stated, the focus of the response cost curve variance analyses is to improve the accuracy of the shape and level of these curves (see FIG. 13). This improvement involves the determination as to whether the level was right as determined by D(Q), X% was right, or Y% was right. Any one, two or all three could be wrong and can be changed for the next period (p+1) as a result of the variance analyses.

It is recognized that supply-related quantity assumption changes can also create demand aberrations during the planning period p. If such aberrations occur, it is assumed that a new MP(p) was developed to reflect the changes, as described above. If the occurred so close to the end of the period p that a revised MP(p) did not made sense to create, the only recourse is to make appropriate supply-related quantity assumption changes for the next planning period (p+1).

There are undoubtedly a variety of ways to perform response cost curve variance analyses, and some possibilities are described herein. However, regardless of which technique is taken, some general principles apply. First, the objective of all these analyses is for the sales, marketing, and/or finance executives to analyze the results of period p and, on the basis of the analysis, make more informed decisions about the next planning period's response curves. This analysis is accomplished by the executives integrating their knowledge of the results of the analyses with their knowledge of the marketplace, including all the things that happened during plan period p that influenced demand, either up or down, in their judgment (e.g., prices being different than plan, sales and marketing programs having a different impact than anticipated, competition responding differently than originally thought, etc.) to make three key decisions for each of the response curves. These decisions include: (1) Which of the t X%s and Y%s should be changed or left the same for the next period p+1? The t X%s and Y%s are the numbers that determine the shape of the response curves; and (2) Which of the t Dfs were wrong for the period p (high or low), and how should that knowledge influence the Dfs for period p+1? This analysis determines the level of the response curves.

A second important principle to keep in mind during post-plan variance analyses is that, just because the data suggests one thing (e.g., the DD($) generated more demand than anticipated), does not mean that such data should be reflected in the next periods' data. Any one or more of the qualitative factors being considered (e.g., competitive action, different prices, etc.) could have created the results—not DD($). Thus, the collective judgment of the executives is necessary for the key decisions regarding the shape and level of the response curves.

A third principle to keep in mind during post-plan variance analysis is that the objective is to shorten the planning horizon and to allow finer granularity and targeting of demand driver expenditures, including increase or decrease in demand driver expenditures (e.g., sales plan, brand $, channel $, etc.) to more or less profitable products, brands, channels, geographies, etc. This finer granularity and targeting of demand drivers would be reflected in more than t response curves.

Possible approaches to response cost curve variance analyses are illustrated in FIG. 16. The approaches illustrated in FIG. 16 are, for clarity, divided into two steps. The first step is gathering the data. The second step is analyzing the data.

The easiest set of data to develop are those comparing actual results with planned results, within a year and between years, step 150. The most obvious of these is use the traditional variance analyses approach of normalizing the results for the key cost driver. In the traditional case, the key cost driver is volume. For the present invention, the key cost driver is demand driver costs. Thus, the first comparative data set are the (t) sets created by comparing the planned demand Dp with the demand that would have been expected if the planned demand driver, Dp, had been the actual demand driver, DDa. Note that it is assumed that DDa is within DDp±20%. As noted earlier, all the detail which was summed from TP(p) to create each DDp and which constituted each DDa should be included in the data set. For example, advertising, sales, promotion, public relations and publicity, personal selling, and direct marketing expenditures should be included in the data set. This allows creation of additional (t) data sets: DDa and DDp details. A variety of additional data sets can be hypothesized, including multi-period data when available.

An alternative to the comparative normalization step 150, represented in FIG. 16 by step 152, is to normalize MP(p) for demand driver costs by forcing the actual t demand driver costs from period p into the solution, and optimizing, thereby creating MPn(p), i.e., the normalized MP(p) model. Another alternative of normalization step 150, represented in FIG. 16 by step 154, is only possible if the executives felt confident of their judgments. Specifically, to create new response curves on the basis of the actual demand driver expenditures and the actual demands. These new response curves could then replace the original response curves in MP(p) creating MPn(p) model. The results of this analysis would be a normalized model, not a normalized solution as in step 152.

After date is gathered according to step 150, 152, and/or 154, the data is then analyzed. There are two ways to analyze any data—quantitatively and qualitatively. Qualitative analysis is represented on FIG. 16 as step 156. At step 156, based on the t sets of data created at step 150, a scatter diagram may be plotted to look for logical explanations. Alternatively, given the normalized MPn(p) solution developed in step 152, data is developed which would show which products/customers, etc. were in both the original MP(p) solutions and the normalize MP(p) solution, looking for judgmental insights into the response curves for (p+1). At step 156, based on the MPn(p) model created at step 154, appropriate profit profiles using MPn(p) and MP(p) are created in step 158 and analyzed in step 156. Such profiles could comprise a variety of “whale curve” profit profiles. Two profiles are product and total demand driver expenditures. Key to analysis of such profit profiles is the observation of which products associated with which response curves are forced out of the solution or added to the solution as the volumes and expenditures are constrained or increased.

Included in all the aforementioned types of analysis in step 150 is the DD($) detail data. This includes the planned and actual demand driver expenditures described above, as well as multi-period data as it becomes available. Also, the knowledge of executives, see step 162, may influence the qualitative analysis performed at step 156.

With regard to quantitatively analyzing data, regression analysis may be the most beneficial tool. The regression analysis of step 160 may be performed from the t sets of data created in step 150, the normalized solutions created in step 152, or the profit profiles of step 158 created from the normalized model created on step 154. Such analysis may be formulated by the company itself using regression analysis tools known in the art, such as SAS/SAT, available from SAS of Cary, N.C.

Other types of quantitative analysis that can be done in step 160 include decision calculus and marketing mix modeling analysis. Quoting from Clancy and Krieg, at page 253, “In what Little calls ‘decision calculus’, we rely upon the judgment of knowledgeable people in a company, sometimes aided by their marketing consulting firm or advertising agency.” See step 162. With regard to marketing mix modeling, in simple terms, this process uses analytics including multivariate statistics to measure the incremental volume from each type of marketing activity. This technique measures all driving factors simultaneously, so that accurate measurements can be made, even if marketing events are happening concurrently. The methodology of marketing mix models can measure virtually anything that has a material impact on a business, as long as data exists that reflects its activity.

Insights obtained from all of the qualitative analyses (step 156) and all of quantitative analysis (step 160) are used by the sales, marketing, and/or financial executives to form the demand-driver response curves for next period (p+1). Thus, as illustrated in FIG. 16, after completion of qualitative analysis step 156 and/or quantitative analysis step 160, one proceeds to the next period, as indicated by step 164. Step 164 corresponds to step 98 in FIG. 6, and, as such, provides input to both steps 86 and 90 of FIG. 6 for the next period (p+1). By the analysis of FIG. 16, a company refines understanding of the real shape of its unique demand-driver or response cost curves over time. As previously stated, such analyses also allows for finer granularity and targeting of demand driver expenditures over time, including the increase/decrease of demand driver expenditures (e.g., sales plan, brand $, channel $) to more/less profitable products, brands, channels, geographies, etc.

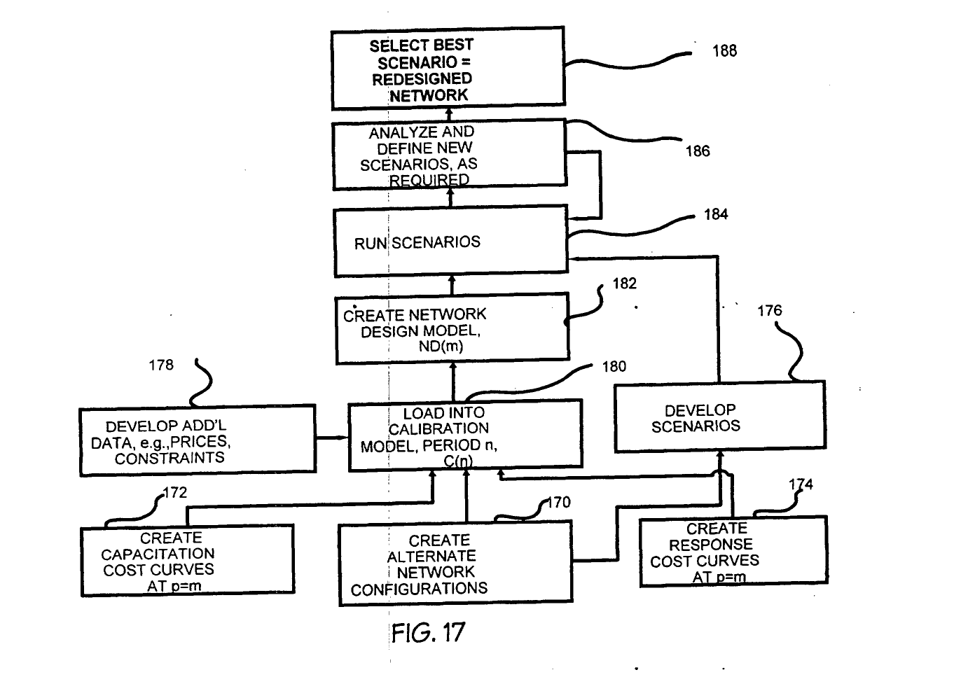

Referring now to FIG. 17, there is shown a flow chart of network design according to one embodiment of the present invention. For FIG. 17, it is assumed the most recent prior year is n and the planning horizon at which the network is being designed is year m, typically 3-5 years in the future. According to this embodiment, alternate network configurations are created at step 170 consistent with the prior art. At step 172, capacitation cost curves at p=m are created at step 172 consistent with the prior art for supply chain costs, and according to the present invention for non-supply chain costs. In addition, response cost curves at p=m are created at step 174 consistent with the present invention. Scenarios are developed at step 176 and additional required data (e.g., prices, constraints) are developed at step 178 consistent with the prior art and according to the present invention. The alternate network configurations created in step 170, capacitation cost curves created in step 172, response cost curves created in step 174, and additional required data developed in step 178 are all loaded into the calibration model for period n to produce the network design model, ND(m) in step 182. The contributions of response cost curves in step 174 are unique to the present invention, as are the contributions of the capacitation curves for non-supply chain costs in step 172.

After the network design model, ND(m) is developed in step 182 the scenarios developed in step 176 are run in network design model ND(m) in step 184. Next, the results of running scenarios in step 184 is analyzed at step 186, and, any new scenarios required are defined in step 186. Steps 184 and 186 may be repeated as necessary until, at step 188, a scenario has been found which created a network that best meets the company's business objectives. These objectives are typically explicitly in developing the alternate network configurations and associated object functions in step 170.

It will be appreciated by those of skill in the art that the system and method of the present invention can be used to maximize planned profit by integrating sales and marketing planning and budgeting with the current supply chain. The system and method of the present invention considers data representative of the costs of goods sold, physical SG&A costs, and non-physical SG&A costs without the requirement of allocating any of these costs. Further, demand drivers expenditures are represented and integrated into the system and method of the present invention, thereby resulting in a system and method that represents many more business activities and processes than prior art network design systems and methods.

It will also be appreciated that the network design of the present invention is more optimal than prior art network designs. The optimality of a network design is a function of the extent to which various elements are fixed as opposed to being available for optimization. According to the present invention, more elements, namely, demands, are available for optimization, yet, the number of elements is reasonable for the user to comprehend and utilize.

It will be further appreciated that the integration of the sales and marketing planning and budgeting processes with the supply chain network design and management has several advantages over prior art systems. The present invention avoids missed profit opportunity and is able to maximize profit by considering demand drivers and employing true optimization techniques. The present invention permits for comparison using object functions other than profit (such as earnings before interest, taxes, depreciation and amortization, shareholder value, economic value, customer equity, etc.) to assess the extent to which different corporate objectives are compatible. By use of the present invention, sales and marketing budgets can be realigned when significant changes in performance or assumptions occur during execution. Cost relationships as a function of volume for the additional costs including SG&A expenses and the volume relationships as a function of demand driver costs are made more accurate over time.

It will be yet further appreciated that the present invention is not solely dependent upon the past for planning. Unlike prior art systems that rely upon the past to predict the future, and, as a result, may only account for inflation, the integration of past data, adjustments for changes, and analysis and evolution of the model mean that the models takes many more variables into account.

It is desired that, as the planning horizon is reduced, the system and method of the present invention be continuously updated at the end of each subperiod, such as a month, when significant changes of whatever origin that would cause the current plan, MP(p), to be invalid. To achieve this objective, the present invention should become a business process distinct from the annual planning process, while remaining appropriately synchronized with it. The ability of a company to adopt such a continuous planning process will, obviously, take time as cultures and systems will have to adapt.

It will be still further appreciated that the system and method of the present invention do not require the collection of a great level of detail, thereby reducing total prior art administrative costs across all uses of the present invention. In addition, the present invention covers all spending without resorting to allocating budgeting techniques as is required in the activity-based budgeting technique or in strategic activity-based management.

It will be yet still further appreciated that the present invention allows for the generation of fully loaded profiles for either products or customers, to generate accurate non-fully loaded profiles for either products or customers, to generate profiles for more than one attribute at a time, and to generate predictive profiles. These advantages can be realized because the cost/volume relationships are not made arbitrarily linear by assuming an allocation scheme and because fixed costs are not ignored.

It will also be appreciated that the system and method of the present invention, in addition to the maximization of planned profit, simultaneously develops a company-wide activity-based budget, predictive product/customer/etc. profit profiles, and historic product/customer/etc. profit profiles, and, subsequently optimizes the supply chain's design by using the information so developed by the present invention.

The present invention can be further modified within the scope and spirit of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

I claim:

1. A supply chain network design system for optimizing profitability, the system comprising:
at least one data storage media for storing data processed by the system and used in development of a network design, the data comprising
data representative of the cost of goods sold, and
data representative of non-physical selling, general, and administrative expenses.

2. The system of claim 1, wherein the data representative of costs of goods sold consists of data representative of one or more of the group of procurement, an inbound network, and manufacturing.

3. The system of claim 1, further comprising data representative of physical selling, general, and administrative expenses.

4. The system of claim 3, wherein the physical data comprises data representative of an outbound network.

5. The system of claim 1, wherein the non-physical data consists of data representative of one or more of the group of sales and marketing expense, customer financial expenses, costs associated with a customer, costs associated with a product, costs independent of a customer, or costs independent of a product.

6. A supply chain network design system for optimizing profitability, the system comprising:
at least one processor; and
at least one database operatively connected to the at least one processor, the at least one database capable of storing response cost curves and capacitation cost curves, the capacitation cost curves including non-physical selling, general, and administrative costs,
the at least one processor operable to create a calibration model using the response cost curves and the capacitation cost curves, and to create a network design model from the calibration model.

7. A method for creating a network design model for a time period, the method comprising the steps of:
creating response cost curves;
creating capacitation cost curves, the capacitation cost curves including non-physical selling, general, and administrative costs;
creating alternate network configurations;
loading the created response cost curves, capacitation cost curves, and alternate network configurations into a calibration model; and
creating a network design model from the calibration model, such that the network design model considers demand as a variable.

8. A planning and budgeting and supply chain management system, comprising:
a processor for creation of a three-dimensional profit planning and analysis solution space, the first dimension of the space comprising volume, the second dimension of the space comprising profit, and the third dimension of the space comprising scenario assumptions, wherein the scenario assumptions include those assumptions related to demand drivers.

9. The system of claim 8, wherein the demand drivers include data representative of one or more of a group consisting of advertising, sales promotion, public relations and publicity, personal selling, and direct marketing expenditures.

10. A planning and budgeting system, comprising:
at least one processor;
at least one database operatively connected to the at least one processor, the at least one database capable of storing response cost curves and capacitation cost curves, the capacitation cost curves including both non-physical selling, general, and administrative costs and supply chain costs,
the at least one processor operable to create a calibration model using the response cost curves and the capacitation cost curves, and to create a planning and budgeting model from the calibration model, the at least one processor using optimization techniques to create the calibration model and the planning and budgeting model.

11. A method of planning and budgeting, the method comprising the steps of:
creating response cost curves;
creating capacitation cost curves, the capacitation cost curves including non-physical selling, general, and administrative costs;
loading the created response cost curves and capacitation cost into a calibration model;
loading appropriate additional data developed by traditional planning and budgeting techniques into the calibration model; and
creating a planning and budgeting model from the calibration model by the use of optimization techniques, such that the planning and budgeting model considers demand as a variable.

12. A system for historic whale curve analysis for a time period, the system comprising:
at least one processor; and
at least one database operatively connected to the at least one processor, the at least one database capable of storing response cost curves and capacitation cost curves, the capacitation cost curves including non-physical selling, general, and administrative costs,
the at least one processor operable to create a calibration model using the response cost curves and the capacitation cost curves, the at least one processor using optimization techniques to create the calibration model, and the at least one processor operable to produce profit profiles with multiple criteria for the time period.

13. A method for historic whale curve analysis for a time period, the method comprising the steps of:
creating a calibration model with response curves for a time period; and
creating whale curves for the time period using simultaneous criteria and optimization techniques.

14. A system for predictive whale curve analysis, the system comprising:
at least one processor; and
at least one database operatively connected to the at least one processor, the at least one database capable of storing an optimized planning and budgeting model
wherein the at least one processor operable to use optimization techniques to create predictive whale curves for the next time period using simultaneous criteria, based on the response cost curves for the next time period.

15. A method for predictive whale curve analysis, the method comprising the steps of:
creating appropriate sets of multiple criteria for creating predictive whale curves;
loading the created criteria into an optimized planning an budgeting model for the next time period; and
performing whale curve analysis for the next time period.

16. A method for budgeting, planning, and supply chain management for a time period, the method comprising the steps of:
calibrating the system by collecting data, including p/l, from a previous time period, by collecting response cost curves representative of the previous time period, by building a calibration model for the previous time period, by loading the collected data and response cost curves from the previous time period into the calibration model for the previous time period, and by calibrating the calibration model;
creating analysis scenarios for the previous time period, loading the previous period analysis scenarios into the calibration model one at a time for the previous time period, and creating a volume/profit/scenario solution space for the previous time period based on the results of running the previous period analysis scenarios;
performing pre-plan analysis by comparing the solutions plotted in the space and the data for the previous time period to inform, for the next time period, the most appropriate scenarios, response cost curves, capacitation cost curves, and other model criteria;
creating an initial plan model for the next period by loading appropriate data developed by traditional planning and budgeting techniques into the initial plan model;
creating analysis scenarios for the time period, loading the analysis scenarios for the time period into the initial plan model, one at a time, creating a volume/profit/scenario solution space for the next time period based on the results of running the analysis scenarios for the time period; and
performing plan analysis by comparing the solutions plotted in the space and the initial plan to select the scenario whose solution best meets a company's objectives to produce an optimized plan that replaces the initial plan.

17. The method of claim 16, further comprising the step of:
making in-period correction to the optimized plan by determining whether significant changes have occurred, and, if any significant changes have occurred, creating scenario(s) relevant to changes, developing associated revised model data, running scenario(s) and select a new maximized profit model which results best meets the business objectives, and revising the supply chain planning and budgeting model based on the selected maximized profit model costs and volumes.

18. The method of claim 16, wherein the significant changes determined include one of the group consisting of aggregation changes, significant cost variances, missed interim financial checkpoints, or changes in assumptions.

19. The method of claim 16, further comprising the step of:
performing post-plan analysis by variance analyses of actual performance versus planned performance.
